(19) United States
(12) Patent Application Publication
(10) Pub. No.: US 2021/0297892 A1
(43) Pub. Date: Sep. 23, 2021

(54) Integrated Access Backhaul Nodes that Support Multiple Mobile Terminations

(71) Applicant: Telefonaktiebolaget LM Ericsson (publ), Stockholm (SE)

(72) Inventors: Oumer Teyeb, Solna (SE); Gunnar Mildh, Sollentuna (SE); Ajmal Muhammad, Sollentuna (SE); Boris Dortschy, Hägersten (SE); Per-Erik Eriksson, Stockholm (SE)

(21) Appl. No.: 17/263,219

(22) PCT Filed: Jun. 28, 2019
(86) PCT No.: PCT/SE2019/050644

§ 371 Date: Jan. 26, 2021

Related U.S. Application Data
(60) Provisional application No. 62/711,284, filed on Jul. 27, 2018.

(51) Int. Cl. H04W 28/02; H04W 40/22

(52) U.S. Cl. CPC H04W 28/0263; H04W 84/047; H04W 40/22

(57) ABSTRACT

A relay node, configured for mapping end-user bearers to backhaul bearers for communications with a distributed unit, DU, of a donor base station, maps (2062) first end-user bearers to a first set of backhaul bearers for communications with the DU via a first mobile termination, MT, entity in the relay node, maps (2604) second end-user bearers to a second set of backhaul bearers for communications with the DU via a second MT entity in the relay node and exchanges (2606) data with the DU over the first and second sets of backhaul bearers, via the first and second MT entities, respectively.

### TECHNICAL FIELD

The present disclosure is generally related to wireless communication networks and is more particularly related to configuring and operating a relay node for mapping end-user bearers to backhaul bearers for communications with a distributed unit (DU) of a donor base station.

### BACKGROUND

FIG. 1 illustrates a high-level view of the fifth-generation (5G) network architecture for the 5G wireless communications system currently under development by the 3^{rd}-Generation Partnership Project (3GPP), consisting of a Next Generation Radio Access Network (NG-RAN) and a 5G Core (5GC). The NG-RAN can comprise a set of gNodeB's (gNBs) connected to the 5GC via one or more NG interfaces, whereas the gNBs can be connected to each other via one or more Xn interfaces. Each of the gNBs can support frequency division duplexing (FDD), time division duplexing (TDD), or a combination thereof. The radio technology for the NG-RAN is often referred to as “New Radio” (NR).

The NG RAN logical nodes shown in FIG. 1 (and described in 3GPP TS 38.401 and 3GPP TR 38.801) include a Central Unit (CU or gNB-CU) and one or more Distributed Units (DU or gNB-DU). The CU is a logical node that is a centralized unit that hosts high layer protocols, including terminating the Packet Data Convergence Protocol (PDCP) and Radio Resource Control (RRC) protocols towards the UE, and includes a number of gNB functions, including controlling the operation of DUs. A DU is a decentralized logical node that hosts lower layer protocols, including the Radio Link Control (RLC), Medium Access Control (MAC), and physical layer protocols, and can include, depending on the functional split option, various subsets of the gNB functions. (As used herein, the terms “central unit” and “centralized unit” are used interchangeably, and the terms “distributed unit” and “decentralized unit” are used interchangeability.) The gNB-CU connects to gNB-DUs over respective F1 logical interfaces, using the F1 application part protocol (F1-AP) which is defined in 3GPP TS 38.473. The gNB-CU and connected gNB-DUs are only visible to other gNBs and the 5GC as a gNB, i.e., the F1 interface is not visible beyond gNB-CU.

As noted above, the CU can host protocols such as RRC and PDCP, while a DU can host protocols such as RLC, MAC and PHY. Other variants of protocol distributions between CU and DU can exist, however, such as hosting the RRC, PDCP and part of the RLC protocol in the CU (e.g., Automatic Retransmission Request (ARQ) function), while hosting the remaining parts of the RLC protocol in the DU, together with MAC and PHY. In some exemplary embodiments, the CU can host RRC and PDCP, where PDCP is assumed to handle both UP traffic and CP traffic. Nevertheless, other exemplary embodiments may utilize other protocol splits that by hosting certain protocols in the CU and certain others in the DU. Exemplary embodiments can also locate centralized control plane protocols (e.g., PDCP-C and RRC) in a different CU with respect to the centralized user plane protocols (e.g., PDCP-U).

It has also been agreed in 3GPP RAN3 Working Group (WG) to support a separation of the gNB-CU into a CU-CP (control plane) function (including RRC and PDCP for signaling radio bearers) and CU-UP (user plane) function (including PDCP for user plane). The CU-CP and CU-UP parts communicate with each other using the E1-AP protocol over the E1 interface. The CU-CP/UP separation is illustrated in FIG. 2.

Densification via the deployment of more and more base stations (e.g., macro or micro base stations) is one of the mechanisms that can be employed to satisfy the increasing demand for bandwidth and/or capacity in mobile networks, which is mainly driven by the increasing use of video streaming services. Due to the availability of more spectrum in the millimeter wave (mmw) band, deploying small cells that operate in this band is an attractive deployment option for these purposes. However, the normal approach of connecting the small cells to an operator's backhaul network with optical fiber can end up being very expensive and impractical. Employing wireless links for connecting the small cells to the operator's network is a cheaper and more practical alternative. One such approach is an integrated access backhaul (IAB) network, where the operator can utilize part of the available radio resources for the backhaul link.

IAB has been studied earlier in 3GPP in the scope of Long Term Evolution (LTE) Release 10 (Rel-10). In that work, an architecture was adopted where a Relay Node (RN) has the functionality of an LTE eNB and UE modem. The RN is connected to a donor eNB which has a S1/X2 proxy functionality hiding the RN from the rest of the network. That architecture enabled the Donor eNB to also be aware of the UEs behind the RN and hide any UE mobility between Donor eNB and Relay Node on the same Donor eNB from the CN. During the Rel-10 study, other architectures were also considered including, e.g., where the RNs are more transparent to the Donor gNB and allocated a separate stand-alone P/S-GW node.

For 5G/NR, similar options utilizing IAB can also be considered. One difference compared to LTE is the gNB-CU/DU split described above, which separates time-critical RLC/MAC/PHY protocols from less time-critical RRC/PDCP protocols. It is anticipated that a similar split could also be applied for the IAB case. Other IAB-related differences anticipated in NR as compared to LTE are the support of multiple hops and the support of redundant paths.

Currently in 3GPP the following architectures for supporting user plane traffic over IAB node has been captured in 3GPP TS 38.874 (version 0.2.1):

Architecture 1a leverages CU/DU-split architecture. FIG. 3 shows the reference diagram for a two-hop chain of IAB nodes underneath an IAB donor. In this architecture, each IAB node holds a DU and a Mobile Termination (MT), the latter of which is a function residing on the IAB node that terminates the radio interface layers of the backhaul Uu interface toward the IAB donor or other IAB nodes. Effectively, the MT stands in for a UE on the Uu interface to the upstream relay node. Via the MT, the IAB node connects to an upstream IAB node or the IAB donor. Via the DU, the IAB node establishes RLC channels to UEs and to MTs of downstream IAB nodes. For MTs, this RLC channel may refer to a modified RLC*.

The donor also holds a DU to support UEs and MTs of downstream IAB-nodes. The IAB-donor holds a CU for the DUs of all IAB-nodes and for its own DU. Each DU on an IAB-node connects to the CU in the IAB-donor using a modified form of F1, which is referred to as F1*. F1*-U runs over RLC channels on the wireless backhaul between the MT on the serving IAB-node and the DU on the donor. F1*-U provides transport between MT and DU on the serving IAB-node as well as between DU and CU on the donor. An adaptation layer is added, which holds routing information, enabling hop-by-hop forwarding. It replaces the IP functionality of the standard F1-stack. F1*-U may carry a General Packet Radio Service Tunneling Protocol (GTP-U) header for the end-to-end association between CU and DU. In a further enhancement, information carried inside the GTP-U header may be included in the adaption layer. Further, optimizations to RLC may be considered such as applying ARQ only on the end-to-end connection opposed to hop-by-hop. The right side of FIG. 3 shows two examples of such F1*-U protocol stacks. In this figure, enhancements of RLC are referred to as RLC*. The MT of each IAB-node further sustains Non-Access Stratum (NAS) connectivity to the Next Generation Core (NGC), e.g., for authentication of the IAB-node. It further sustains a Protocol Data Unit (PDU)-session via the NGC, e.g., to provide the IAB-node with connectivity to the Operations, Administration and Maintenance (OAM).

Architecture 1b also leverages CU/DU-split architecture. FIG. 4 shows the reference diagram for a two-hop chain of IAB nodes underneath an IAB donor. Note that the IAB donor only holds one logical CU.

In this architecture, each IAB node and the IAB donor hold the same functions as in architecture 1a. Also, as in architecture 1a, every backhaul link establishes an RLC channel, and an adaptation layer is inserted to enable hop-by-hop forwarding of F1*.

As opposed to architecture 1a, the MT on each IAB-node establishes a PDU-session with a UPF residing on the donor. The MT's PDU-session carries F1* for the collocated DU. In this manner, the PDU-session provides a point-to-point link between CU and DU. On intermediate hops, the PDCP-PDUs of F1* are forwarded via adaptation layer in the same manner as described for architecture 1a. The right side of FIG. 4 shows an example of the F1*-U protocol stack.

Various user plane aspects for architecture group 1 include placement of an adaptation layer, functions supported by the adaptation layer, support of multi-hop RLC, impacts on scheduler and QoS.

The UE establishes RLC channels to the DU on the UE's access IAB node in compliance with TS 38.300. Each of these RLC-channels is extended via a potentially modified form of F1-U, referred to as F1*-U, between the UE's access DU and the IAB donor. The information embedded in F1*-U is carried over RLC-channels across the backhaul links.

Transport of F1*-U over the wireless backhaul is enabled by an adaptation layer, which is integrated with the RLC channel. Within the IAB-donor (referred to as fronthaul), the baseline is to use native F1-U stack (3GPP TS 38.474 V15.0.0). The IAB-donor DU relays between F1-U on the fronthaul and F1*-U on the wireless backhaul.

In architecture 1a, information carried on the adaptation layer supports the following functions, among others: identification of the UE-bearer for the PDU; routing across the wireless backhaul topology; Quality-of-Service (QoS)-enforcement by the scheduler on downlink and uplink on the wireless backhaul link; and mapping of UE user-plane PDUs to backhaul RLC channels.

In architecture 1b, information carried on the adaptation layer supports the following functions, among others: routing across the wireless backhaul topology; QoS-enforcement by the scheduler on DL and UL on the wireless backhaul link; and mapping of UE user-plane PDUs to backhaul RLC channels.

Information to be carried on the adaptation layer header may include: UE-bearer-specific Id; UE-specific Id; Route Id, IAB-node or IAB-donor address; QoS information; and potentially other information.

Adaptation layer placements may be integrated with MAC layer or above MAC layer (examples shown in FIGS. 5A, 5B) or above RLC layer (examples shown in FIGS. 5D, 5E and FIG. 6). FIGS. 5 and 6 show example protocol stacks and do not preclude other possibilities. While RLC channels serving for backhauling include the adaptation layer, the adaptation layer may also be included in IAB-node access links (the adaptation layer in the IAB node is illustrated with a dashed outline in FIG. 6).

The adaptation layer may consist of sublayers. It is perceivable, for example, that the GTP-U header becomes a part of the adaptation layer. It is also possible that the GTP-U header is carried on top of the adaptation layer to carry end-to-end association between the IAB-node DU and the CU (an example is shown in FIG. 5D).

Alternatively, an IP header may be part of the adaptation layer or carried on top of the adaptation layer. One example is shown in FIG. 5E. In this example, the IAB-donor DU holds an IP routing function to extend the IP-routing plane of the fronthaul to the IP-layer carried by adapt on the wireless backhaul. This allows native F1-U to be established end-to-end, i.e. between IAB-node DUs and IAB-donor CU-UP. The scenario implies that each IAB-node holds an IP-address, which is routable from the fronthaul via the IAB-donor DU. The IAB-nodes' IP addresses may further be used for routing on the wireless backhaul.

Note that the IP layer on top of Adapt does not represent a PDU session. The MT's first hop router on this IP layer therefore does not have to hold a UPF.

There have been some observations on adaptation layer placement. The above-RLC adaptation layer can only support hop-by-hop ARQ. The above-MAC adaptation layer can support both hop-by-hop and end-to-end ARQ. Both adaptation layer placements can support aggregated routing, e.g., by inserting an IAB-node address into the adaptation header.

Both adaptation layer placements can support per-UE-bearer QoS for a large number of UE-bearers. For above-RLC adaptation layer, the LCID space has to be enhanced since each UE-bearer is mapped to an independent logical channel. For above-MAC adaptation layer, UE-bearer-related info has to be carried on the adaptation header. Both adaptation layer placements can support aggregated QoS handling, e.g., by inserting an aggregated QoS Id into the adaptation header. Aggregated QoS handling reduces the number of queues. This is independent of where the adaptation layer is placed. For both adaptation layer placements, aggregation of routing and QoS handling allows proactive configuration of intermediate on-path IAB-nodes, i.e., configuration is independent of UE-bearer establishment/release. For both adaptation layer placements, RLC ARQ can be pre-processed on the transmission side.

For RLC AM, ARQ can be conducted hop-by-hop along access and backhaul links (FIGS. 5C, 5D, 5E, and FIG. 6). It is also possible to support ARQ end-to-end between UE and IAB-donor (FIGS. 5A, 5B). Since RLC segmentation is a just-in-time process, it is always conducted in a hop-by-hop manner. FIGS. 5 and 6 show example protocol stacks and do not preclude other possibilities.

The type of multi-hop RLC ARQ and adaptation-layer placement have end-to-end ARQ interdependence (adaptation layer is integrated with MAC layer or placed above MAC layer) or no interdependence (hop-by-hop ARQ).

In architecture 1a, the UE's and the MT's UP and RRC traffic can be protected via PDCP over the wireless backhaul. A mechanism has to be defined to also protect F1-AP traffic over the wireless backhaul. The following four alternatives can be considered. Other alternatives are not precluded.

FIGS. 7A, 7B, and 7C show protocol stacks for UE's RRC, MT's RRC and DU's F1-AP for alternative 1. In these examples, the adaptation layer is placed on top of RLC. On the IAB-node's access link, the adaptation layer may or may not be included. The example does not preclude other options.

This alternative has the following main features. The UE's and the MT's RRC are carried over a Signaling Radio Bearer (SRB). On the UE's or MT's access link, the SRB uses an RLC-channel. On the wireless backhaul links, the SRB's PDCP layer is carried over RLC-channels with adaptation layer. The adaptation layer placement in the RLC channel is the same for C-plane as for U-plane. The information carried on the adaptation layer may be different for SRB than for DRB. The DU's F1-AP is encapsulated in RRC of the collocated MT. F1-AP is therefore protected by the PDCP of the underlying SRB. Within the IAB-donor, the baseline is to use native F1-C stack.

FIGS. 8A, 8B, and 8C show protocol stacks for UE's RRC, MT's RRC and DU's F1-AP for alternative 2. In these examples, the adaptation layer resides on top of RLC. On the IAB-node's access link, the adaptation layer may or may not be included. The example does not preclude other options.

This alternative has the following main features. The UE's and the MT's RRC are carried over SRB. On the UE's or MT's access link, the SRB uses an RLC-channel. On the wireless backhaul link, the PDCP of the RRC's SRB is encapsulated into F1-AP. The DU's F1-AP is carried over an SRB of the collocated MT. F1-AP is protected by this SRB's PDCP. On the wireless backhaul links, the PDCP of the F1-AP's SRB is carried over RLC-channels with adaptation layer. The adaptation layer placement in the RLC channel is the same for C-plane as for U-plane. The information carried on the adaptation layer may be different for SRB than for DRB. Within the IAB-donor, the baseline is to use native F1-C stack.

FIGS. 9A, 9B, and 9C show protocol stacks for UE's RRC, MT's RRC and DU's F1-AP for alternative 3. In these examples, the adaptation layer resides on top of RLC. On the IAB-node's access link, the adaptation layer may or may not be included. The example does not preclude other options.

This alternative has the following main features. The UE's and the MT's RRC are carried over SRB. On the UE's or MT's access link, the RRC's SRB uses an RLC-channel. On the wireless backhaul links, the SRB's PDCP layer is carried over RLC-channels with adaptation layer. The adaptation layer placement in the RLC channel is the same for C-plane as for U-plane. The information carried on the adaptation layer may be different for SRB than for DRB. The DU's F1-AP is also carried over an SRB of the collocated MT. F1-AP is protected by this SRB's PDCP. On the wireless backhaul links, the PDCP of the SRB is also carried over RLC-channels with adaptation layer. Within the IAB-donor, the baseline is to use native F1-C stack.

FIGS. 10A, 10B, and 10C show protocol stacks for UE's RRC, MT's RRC and DU's F1-AP for alternative 4. In these examples, the adaptation layer resides on top of RLC and carries an IP-layer.

This alternative has the following main features. The IP-layer carried by adapt is connected to the fronthaul's IP-plane through a routing function at the IAB-donor DU. On this IP-layer, all IAB-nodes hold IP-addresses, which are routable from the IAB-donor CU-CP. IP address assignment to the IAB node could be based IPv6 Neighbor Discovery Protocol where the DU act as an IPv6 router sending out ICMPv6 Router Advertisement over 1 or more backhaul bearer towards the IAB node. Other methods are not excluded.

The extended IP-plane allows native F1-C to be used between IAB-node DU and IAB-donor CU-DP. Signaling traffic can be prioritized on this IP routing plane using DSCP markings in compliance with TS 38.474. F1-C is protected via NDS, e.g. via D-TLS, as established by S3-181838. The UE's and the MT's RRC use SRB, which is carried over F1-C in compliance with TS 38.470.

An IAB node has an MT part (to connect to serving IAB node or the IAB donor DU) and a DU part (that serves the UEs connected to it). One limitation of such an architecture is that the MT part (and the link between it and the serving IAB node or the IAB donor DU) will be used to forward the traffic of all the UEs directly under the IAB node as well as all the IAB nodes (and their UEs) under the concerned IAB node. This could lead to a situation where the MT capability could end up limiting the functions that an IAB system could provide to its UEs, especially in the context of multiple hops.

One example of this problem is that, currently, NR UEs support up to 32 logical channel IDs, of which some are reserved for signaling radio bearers (SRBs) (0,1, 2) while the rest can be used to differentiate the data radio bearers (DRBs). This means, in each hop of the IAB network, QoS differentiation is available for up to 32 flows. In some IAB architectures, (e.g., FIGS. 5C, 5D and 5E), bearers from different UEs will be aggregated (e.g., based the QoS requirements of each bearer) over the same RLC and logical channel IDs. As the number of UEs and the total number of bearers increases, then more and more bearers have to be mapped to the same RLC/LCID, especially at the backhaul links close to the donor DU, as all the traffic downstream has to traverse these links. A problem with this is that some QoS granularity will be lost (e.g., fairness among the different UEs), since the scheduling at the MAC will not differentiate the different chunks (from the bearers of the different UE) in a given logical channel ID (LCID) “pipe”. Also, when a given data arrives at an IAB node, it can contain data for UEs that are one hop, two hops, . . . n-hops away from the IAB node multiplexed over the same LCID pipe. Treating the data of UEs that are at different hops could also lead to unfairness in the system, as those closer to the IAB donor node will experience better service quality (in-terms of end to end latency, for example) as compared to those that are further away.

### SUMMARY

Some aspects of these problems have been addressed, especially the issue of hop aware scheduling. However, to implement hop aware scheduling, more LCID space may be needed. That is, if there is to be a separate pipe for every hop and every QoS profile of bearer, then n x m LCI Ds will be needed, where n is the number of hops supported and m is the number of QoS profiles to be supported.

Embodiments of the present invention address some of the limitations of having a limited LCID space at the MT-network link, which also has other ramifications that lead to more optimal operation of an IAB network. Some embodiments include methods whereby multiple MT entities (either logical or physical) are made available at the IAB node. This way, the LCID space is expanded to the desired level of QoS differentiation, and other possibilities arise such as load balancing, dual connectivity and robust path change.

This ensures good performance for all users even in situations where the UEs are unevenly distributed between IAB nodes (e.g., some IAB nodes serve many UEs and should therefore get relatively more resources on the wireless backhaul interface). The IAB network will be more scalable in terms of number of hops/IAB nodes. For example, without the embodiments described herein, there could be a bottleneck limiting the performance for IAB nodes serving many other IAB nodes.

According to some embodiments, a method, in a relay node, for mapping end-user bearers to backhaul bearers for communications with a DU of a donor base station includes mapping first end-user bearers to a first set of backhaul bearers for communications with the DU via a first MT entity in the relay node. The method also includes mapping second end-user bearers to a second set of backhaul bearers for communications with the DU via a second MT entity in the relay node and exchanging data with the DU over the first and second sets of backhaul bearers, via the first and second MT entities, respectively.

Further aspects of the present invention are directed to an apparatus, an IAB/relay node, computer program products or computer readable storage medium corresponding to the methods summarized above and functional implementations of the above-summarized apparatus and wireless device.

Of course, the present invention is not limited to the above features and advantages. Those of ordinary skill in the art will recognize additional features and advantages upon reading the following detailed description, and upon viewing the accompanying drawings.

### BRIEF DESCRIPTION OF THE FIGURES

FIG. 1 illustrates an example of 5G logical network architecture.

FIG. 2 shows the separation between the control-unit-control-plane (CU-CP) and control-unit-user-plane (CU-UP) functions.

FIG. 3 is a reference diagram for integrated access backhaul (IAB) architecture 1a.

FIG. 4 is a reference diagram for architecture 1b.

FIGS. 5A, 5B, 5C, 5D, and 5E show protocol stack examples for UE access using L2-relaying with adaptation layer, for architecture 1a.

FIG. 6 illustrates a protocol stack example for UE access using L2-relaying with adaptation layer, for architecture 1b.

FIGS. 7A, 7B, and 7C illustrate protocol stacks for alternative 1 of architecture 1a.

FIGS. 8A, 8B, and 8C illustrate protocol stacks for alternative 2 of architecture 1a.

FIGS. 9A, 9B, and 9C illustrate protocol stacks for alternative 3 of architecture 1a.

FIGS. 10A, 10B, and 10C show protocol stacks for alternative 4 of architecture 1a.

FIG. 11 is a block diagram showing a dedicated MT entity per IAB node.

FIG. 12 is a block diagram showing a dedicated MT entity per set of QCI values.

FIG. 13 illustrates components of an example wireless network.

FIG. 14 illustrates an example UE in accordance with some embodiments of the presently disclosed techniques and apparatus.

FIG. 15 is a schematic diagram illustrating a virtualization environment in which functions implemented by some embodiments can be virtualized.

FIG. 16 illustrates an example telecommunication network connected to a host via an intermediate network, in accordance with some embodiments.

FIG. 17 illustrates a host computer communicating over a partially wireless connection with, in accordance with some embodiments.

FIG. 18 shows a base station with a distributed 5G architecture.

FIG. 19 illustrates an example central unit, according to some embodiments.

FIG. 20 illustrates an example design for a central unit.

FIG. 21 is a block diagram illustrating an example IAB/relay node.

FIG. 22 is a flowchart illustrating methods implemented in a communication system that includes a host computer, a base station, and a user equipment, in accordance with some embodiments.

FIG. 23 is another flowchart illustrating methods implemented in a communication system that includes a host computer, a base station, and a user equipment, in accordance with some embodiments.

FIG. 24 shows another flowchart illustrating methods implemented in a communication system that includes a host computer, a base station, and a user equipment, in accordance with some embodiments.

FIG. 25 shows still another flowchart illustrating methods implemented in a communication system that includes a host computer, a base station, and a user equipment, in accordance with some embodiments.

FIG. 26 is a process flow diagram illustrating an example method performed in a relay node.

### DETAILED DESCRIPTION

Exemplary embodiments briefly summarized above will now be described more fully with reference to the accompanying drawings. These descriptions are provided by way of example to explain the subject matter to those skilled in the art and should not be construed as limiting the scope of the subject matter to only the embodiments described herein. More specifically, examples are provided below that illustrate the operation of various embodiments according to the advantages discussed above.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods and/or procedures disclosed herein do not have to be performed in the exact order disclosed, unless a step is explicitly described as following or preceding another step and/or where it is implicit that a step must follow or precede another step. Any feature of any of the embodiments disclosed herein can be applied to any other embodiment, wherever appropriate. Likewise, any advantage of any of the embodiments can apply to any other embodiments, and vice versa. Other objectives, features and advantages of the enclosed embodiments will be apparent from the following description.

In the following description, the term “mother DU” refers to the donor DU or the DU part of the IAB node that is serving a descendant IAB node. The term “CU”, unless otherwise specified, means that the donor CU that is serving the donor DU.

Embodiments of the present invention enable the IAB node to have multiple MT entities/units. These MT entities can be either physically separate (e.g., with separate Tx/Rx units) or they can be logically different (e.g., different protocol stacks) while using the same physical Tx/Rx units. The MTs can be connected to the same mother DU cell, to different cells belonging to the same mother DU, or to different cells and mother DUs. The IAB nodes can connect to their mother DU using these multiple MT entities and thereby benefit from having a multitude of LCIDs that can be used as compared to connecting via a single MT.

The separate MTs can be associated with separate protocol instances of the 3GPP defined protocols such as NAS (authentication, mobility/session management), RRC, SDAP, PDCP, RLC, MAC, PHY. This allows independent operation of the MTs and avoids requirements on tight interaction (e.g., scheduling coordination, measurement gaps, coordinated handover) between the different MTs, thereby simplifying the implementation and hardware/software complexity. Even though independent instances of the protocols are used, the CU serving the MTs can be made aware that the MTs are associated together and/or with the same IAB node. For this purpose, the MTs (or IAB node) may indicate in a signaling message to the CU which MTs are associated with each other. This can be done, for example, by using a common identifier in the signaling message or providing a list of the identities of one or more associated MTs. The information about which MTs are associated with each other could also be provided to the CU from the Core Network (CN). This can be done, for example, by using a common identifier in the signaling message or providing a list of the identities of one or more associated MTs.

A single relay (IAB node) may employ multiple mobile terminal functions in order to increase the capacity/robustness of wireless backhaul links. Capacity/robustness here may refer to several aspects like throughput, LCID space, scheduling flexibility/fairness, reliability, etc. Methods to employ multiple terminal functions may involve setting up and configuring the multiple mobile terminal functions, handling of mobile terminal capability and coordination, scheduling aspects and handling of identifiers (e.g., C-RNTI).

An IAB node can communicate with its mother DU (or CU) the number of MT entities that it can support, or this information can be gathered from the core network from UE/MT registration information. In this capability information, additional information can be provided. Such information may include whether the MTs are logical or physical units, or a combination, such as support for n logical MT entities, support for m physical MT entities, support for x logical and y physical entities, etc. The capability information may include detailed capabilities of each entity. These may include, for example, power limitations, modulation coding schemes supported, bandwidth/frequencies that are supported, support for signaling and/or support for data radio bearers, buffer capability, etc.

Capability information may also include the MT type or usage pattern (e.g., backup MT, primary MT, secondary MT, data only MT, signaling only MT). Capability information may include whether the MTs can connect to the same mother DU or different mother DUs for robustness requirements. Capability information may include information about which IAB DU cells the MT is associated with and any restrictions in the usage of the MT, such as that an MT may not be used/scheduled at the same time as serving UEs in a given cell, if the MT shares the same antenna or radio/RF unit as one of the cells provided by the IAB. This information can be useful for the CU or mother DU since there could be limitations in using the wireless backhaul at the same time as the IAB node is serving its own UEs. Also, different cells can be pointed in different directions which means that they are differently suitable for setting up wireless backhaul paths with other radio nodes or cells.

The capabilities could be provided one by one for each MT unit, or provides as a common capability that is applicable to all entities. The capabilities that are different for each MT may be provided separately. There may also be subcategories so that everything does not have be applicable to either all or only one. There may be a set of capabilities that are applicable to a set of MT entities. In this case, the subcategories can be provided identities and only the category ID may need to be communicated.

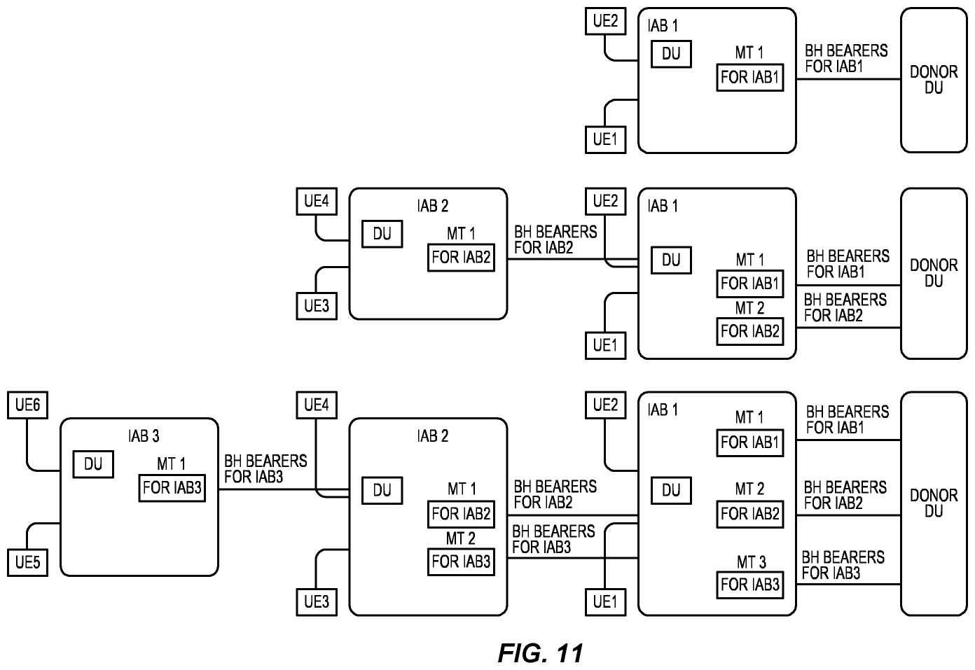

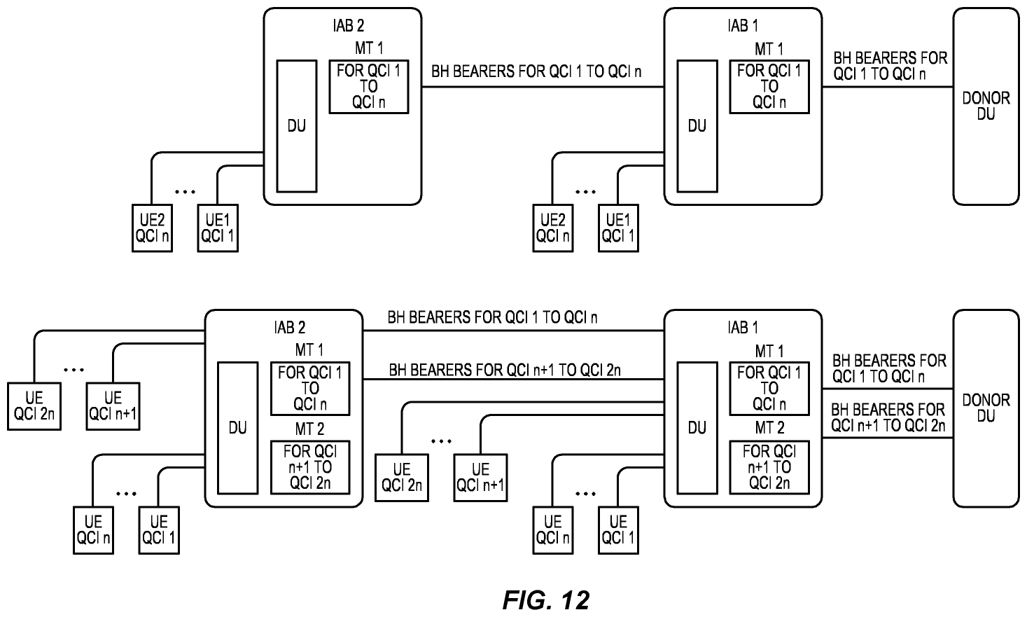

Different MT entities may be instantiated or activated during the IAB node setup/startup procedure or when there is a need to do so. For example, at the beginning, only one MT unit can be started and more MT entities can be instantiated/activated as more and more UEs or IAB nodes get connected to the IAB network (FIG. 11), and more QoS granularity/differentiation is required (FIG. 12). It is also possible to use different MTs for transporting user data and for signaling traffic over the backhaul link. In another example, all the MT entities are instantiated at the startup of the IAB node. In yet another example, a set of MT entities are instantiated at the startup and others later when the need arises. The number of active MT entities per IAB node in an IAB network can vary depending upon the IAB node location (i.e., how many hops between the IAB node and the IAB donor DU), network load, network services/applications QoS requirements, IAB node power usage or limits, IAB node configuration, supported IAB node software licenses, etc.

The determination of whether there is a need to activate more MT entities can be performed by the IAB node, by the mother DU, by the donor DU (in case the mother DU is different from the donor DU) or/and the CU. The determination can be done one by one (e.g., add one more MT entity at a time) or can be done for more than one entity at a time (e.g., add m MT entities at once). To support the case where the determination can be done by the mother DU/CU, new signaling may be introduced from the mother DU/CU to the IAB node, where the IAB node can be instructed to start the setup of an MT or a set of MT entities (current agreement in 3GPP is for the IAB node to initiate the MT setup phase during the IAB setup procedure).

The setup of multiple MT entities can be performed one by one or together in one procedure. For example, if multiple entities are to be setup at the beginning of the IAB setup procedure, the MT setup phase of the IAB node setup procedure can perform the setup of all the MTs at once. Alternatively, separate MT setup phases can be instantiated for each MT entity. A similar mechanism, such as separate or group-wise, can be employed when MTs are being setup/activated while the IAB node is up and running.

Just like the determination for a need to setup/activate more MT entities, methods can be employed to terminate/release MT entities when not needed any more. Instead of releasing the entity or entities directly, a phased approach can be utilized where the entities are suspended at first (e.g., based on the number of active UEs, descendant IAB nodes) and later released (e.g., based on some time out timer). While suspended, the configuration of the suspended entity can be kept both at the IAB node as well as the mother DU and CU. A resume procedure, similar to the LTE/NR UE resume procedures, can be employed to resume a suspended MT entity.

When more than one MT entity is being setup for a given IAB node, some indication can be provided by the IAB node to the mother DU/CU (or vice versa, in the case where it was the mother DU/CU determined the need to setup the IAB node) to ensure the MTs are treated as a set belonging to the same IAB node.

A mother DU can assign multiple C-RNTI values for the IAB node, corresponding to each MT. This can be performed in several ways. The mother DU may assign multiple C-RNTI values as a set of different C-RNTI values (e.g., C-RNTI1, C-RNTI2). The mother DU may assign an initial C-RNTI value and the number of C-RNTIs (e.g., C-RNTI1 and n, which signifies the values C-RNTI1 to C-RNTI1+n are to be used). The mother DU may assign an initial C-RNTI value and a number of additional C-RNTIs calculated using a secure pseudo random number generator (such as a secure hash, e.g., MD5) or other function. The input to the function could be one or more of the initial C-RNTI, a sequence number counting the number of C-RNTIs allocated, some security key associated with the MT connection, or some NOUNCE (number only used once) which has been exchanged between MT and network. A common C-RNTI value can also be provided on top of the individual C-RNTIs that is applicable to all MTs. This common C-RNTI could be used when sending signaling data that is common to all MT entities.

In some cases, the lower layer configurations (apart from C-RNTI and other relevant identities) may be shared/common among the different MT entities and thus can be signaled to the IAB node only once (to be then communicated internally within the IAB node among the different MTs). In other cases, the common C-RNTI value may be used to schedule the signaling, so that each individual MT can get the configuration explicitly. The lower layer configurations for the different MT units could also be signaled separately for each MT unit. “Separately” here means either in different RRC messages or in different containers within the same message, where identifiers are included to indicate which part belong to which MT.

When the different MT entities connect, it may not be necessary for each entity to perform a random access procedure towards the mother DU, and thus only one random access procedure could be used, whereby the timing advance as well as the needed C-RNTIs can be provided. Another alternative is to re-use the current NR/LTE concept where a random access is required for each MT establishing a connection. Similar options are also possible for other signaling such as connection setup, authentication, etc., where either the MTs are connected with via a single connection setup, authentication or where they perform separate connection setup and authentication per MT.

In the case where the MTs are only logically different and are all connected to the same mother DU, then the scheduling of the different MTs have to rely on time/frequency resources. In the case of physically separate MTs, the MTs could be scheduled concurrently, depending on the capabilities of the MTs, such as with regard to isolation between the different transmitter chains (e.g., avoiding harmful out of band transmissions due to inter-modulation between two different signals). In the case where it is required by the scheduler in the mother DU to coordinate the transmission of the different MTs connected to the mother DU, this can be done in different ways. For example, the mother DU may assign adjacent resources to the MTs since this may put less constraints on MTs sharing the same transmitter. The mother DU may avoid the scheduling of the different MTs on the same frequency or same time slot or both.

The mother DU may prioritize between the different MTs using different schemes, such as equal (where each MT gets a share of the resources in a round robin manner). Some MTs may have higher priority than others, such as bearers or/and UEs with high priority mapped to certain MTs, and these MTs will have a higher priority. MTs sending signaling could get higher or lower priorities than MTs sending user data. MTs that are carrying data for bearers several hops away (as illustrated in FIG. 11) may have higher priority than the MTs carrying data for bearers few hops away.

The mother DU may consider power constraints in the scheduling. For example, the mother DU may avoid the assignment of high uplink power to the MT transmission if the IAB node associated with that MT is also at the same time transmitting (or scheduled to transmit) with another MT.

The mother DU may apply fairness techniques where the resource requests (e.g., scheduling request, buffer status reports) associated with MTs belonging to the same IAB node are considered together, thus avoiding the case when IAB nodes with multiple MTs are assigned more resources than IAB nodes which fewer MTs.

These methods can be performed internally in the DU scheduler, or could be based on explicit signaling between the DU and MTs (e.g., with specific scheduling commands).

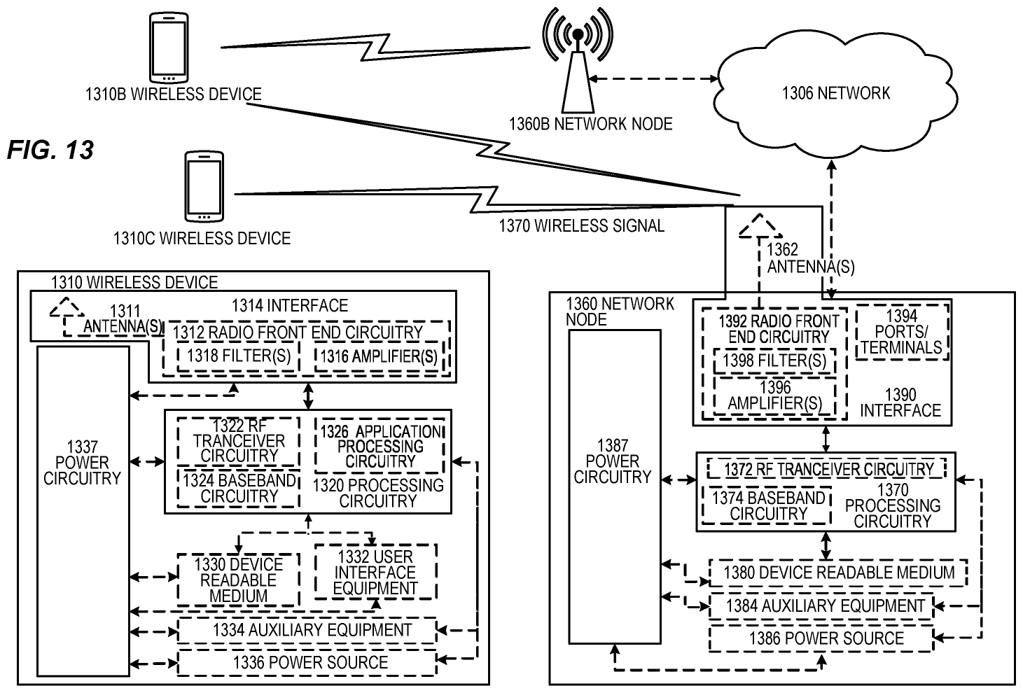

Although the subject matter described herein can be implemented in any appropriate type of system using any suitable components, the embodiments disclosed herein are described in relation to a wireless network, such as the example wireless network illustrated in FIG. 13. For simplicity, the wireless network of FIG. 13 only depicts network 1306, network nodes 1360 and 1360B, and WDs 1310, 1310B, and 1310C. In practice, a wireless network can further include any additional elements suitable to support communication between wireless devices or between a wireless device and another communication device, such as a landline telephone, a service provider, or any other network node or end device. Of the illustrated components, network node 1360 and wireless device (WD) 1310 are depicted with additional detail. The wireless network can provide communication and other types of services to one or more wireless devices to facilitate the wireless devices' access to and/or use of the services provided by, or via, the wireless network.

The wireless network can comprise and/or interface with any type of communication, telecommunication, data, cellular, and/or radio network or other similar type of system. In some embodiments, the wireless network can be configured to operate according to specific standards or other types of predefined rules or procedures. Thus, particular embodiments of the wireless network can implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 1306 can comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 1360 and WD 1310 comprise various components described in more detail below. These components work together in order to provide network node and/or wireless device functionality, such as providing wireless connections in a wireless network. In different embodiments, the wireless network can comprise any number of wired or wireless networks, network nodes, base stations, controllers, wireless devices, relay stations, and/or any other components or systems that can facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations can be categorized based on the amount of coverage they provide (or, stated differently, their transmit power level) and can then also be referred to as femto base stations, pico base stations, micro base stations, or macro base stations. A base station can be a relay node or a relay donor node controlling a relay. A network node can also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station can also be referred to as nodes in a distributed antenna system (DAS).

Further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node can be a virtual network node as described in more detail below. More generally, however, network nodes can represent any suitable device (or group of devices) capable, configured, arranged, and/or operable to enable and/or provide a wireless device with access to the wireless network or to provide some service to a wireless device that has accessed the wireless network.

In FIG. 13, network node 1360 includes processing circuitry 1370, device readable medium 1380, interface 1390, auxiliary equipment 1384, power source 1386, power circuitry 1387, and antenna 1362. Although network node 1360 illustrated in the example wireless network of FIG. 13 can represent a device that includes the illustrated combination of hardware components, other embodiments can comprise network nodes with different combinations of components. It is to be understood that a network node comprises any suitable combination of hardware and/or software needed to perform the tasks, features, functions and methods and/or procedures disclosed herein. Moreover, while the components of network node 1360 are depicted as single boxes located within a larger box, or nested within multiple boxes, in practice, a network node can comprise multiple different physical components that make up a single illustrated component (e.g., device readable medium 1380 can comprise multiple separate hard drives as well as multiple RAM modules).

Similarly, network node 1360 can be composed of multiple physically separate components (e.g., a NodeB component and a RNC component, or a BTS component and a BSC component, etc.), which can each have their own respective components. In certain scenarios in which network node 1360 comprises multiple separate components (e.g., BTS and BSC components), one or more of the separate components can be shared among several network nodes. For example, a single RNC can control multiple NodeB's. In such a scenario, each unique NodeB and RNC pair, can in some instances be considered a single separate network node. In some embodiments, network node 1360 can be configured to support multiple radio access technologies (RATs). In such embodiments, some components can be duplicated (e.g., separate device readable medium 1380 for the different RATs) and some components can be reused (e.g., the same antenna 1362 can be shared by the RATs). Network node 1360 can also include multiple sets of the various illustrated components for different wireless technologies integrated into network node 1360, such as, for example, GSM, WCDMA, LTE, NR, WiFi, or Bluetooth wireless technologies. These wireless technologies can be integrated into the same or different chip or set of chips and other components within network node 1360.

Processing circuitry 1370 can be configured to perform any determining, calculating, or similar operations (e.g., certain obtaining operations) described herein as being provided by a network node. These operations performed by processing circuitry 1370 can include processing information obtained by processing circuitry 1370 by, for example, converting the obtained information into other information, comparing the obtained information or converted information to information stored in the network node, and/or performing one or more operations based on the obtained information or converted information, and as a result of said processing making a determination.

Processing circuitry 1370 can comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1360 components, such as device readable medium 1380, network node 1360 functionality. For example, processing circuitry 1370 can execute instructions stored in device readable medium 1380 or in memory within processing circuitry 1370. Such functionality can include providing any of the various wireless features, functions, or benefits discussed herein. In some embodiments, processing circuitry 1370 can include a system on a chip (SOC).

In some embodiments, processing circuitry 1370 can include one or more of radio frequency (RF) transceiver circuitry 1372 and baseband processing circuitry 1374. In some embodiments, radio frequency (RF) transceiver circuitry 1372 and baseband processing circuitry 1374 can be on separate chips (or sets of chips), boards, or units, such as radio units and digital units. In alternative embodiments, part or all of RF transceiver circuitry 1372 and baseband processing circuitry 1374 can be on the same chip or set of chips, boards, or units

In certain embodiments, some or all of the functionality described herein as being provided by a network node, base station, eNB or other such network device can be performed by processing circuitry 1370 executing instructions stored on device readable medium 1380 or memory within processing circuitry 1370. In alternative embodiments, some or all of the functionality can be provided by processing circuitry 1370 without executing instructions stored on a separate or discrete device readable medium, such as in a hard-wired manner. In any of those embodiments, whether executing instructions stored on a device readable storage medium or not, processing circuitry 1370 can be configured to perform the described functionality. The benefits provided by such functionality are not limited to processing circuitry 1370 alone or to other components of network node 1360, but are enjoyed by network node 1360 as a whole, and/or by end users and the wireless network generally.

Device readable medium 1380 can comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that can be used by processing circuitry 1370. Device readable medium 1380 can store any suitable instructions, data or information, including a computer program, software, an application including one or more of logic, rules, code, tables, etc. and/or other instructions capable of being executed by processing circuitry 1370 and, utilized by network node 1360. Device readable medium 1380 can be used to store any calculations made by processing circuitry 1370 and/or any data received via interface 1390. In some embodiments, processing circuitry 1370 and device readable medium 1380 can be considered to be integrated.

Interface 1390 is used in the wired or wireless communication of signaling and/or data between network node 1360, network 1306, and/or WDs 1310. As illustrated, interface 1390 comprises port(s)/terminal(s) 1394 to send and receive data, for example to and from network 1306 over a wired connection. Interface 1390 also includes radio front end circuitry 1392 that can be coupled to, or in certain embodiments a part of, antenna 1362. Radio front end circuitry 1392 comprises filters 1398 and amplifiers 1396. Radio front end circuitry 1392 can be connected to antenna 1362 and processing circuitry 1370. Radio front end circuitry can be configured to condition signals communicated between antenna 1362 and processing circuitry 1370. Radio front end circuitry 1392 can receive digital data that is to be sent out to other network nodes or WDs via a wireless connection. Radio front end circuitry 1392 can convert the digital data into a radio signal having the appropriate channel and bandwidth parameters using a combination of filters 1398 and/or amplifiers 1396. The radio signal can then be transmitted via antenna 1362. Similarly, when receiving data, antenna 1362 can collect radio signals which are then converted into digital data by radio front end circuitry 1392. The digital data can be passed to processing circuitry 1370. In other embodiments, the interface can comprise different components and/or different combinations of components.

In certain alternative embodiments, network node 1360 may not include separate radio front end circuitry 1392, instead, processing circuitry 1370 can comprise radio front end circuitry and can be connected to antenna 1362 without separate radio front end circuitry 1392. Similarly, in some embodiments, all or some of RF transceiver circuitry 1372 can be considered a part of interface 1390. In still other embodiments, interface 1390 can include one or more ports or terminals 1394, radio front end circuitry 1392, and RF transceiver circuitry 1372, as part of a radio unit (not shown), and interface 1390 can communicate with baseband processing circuitry 1374, which is part of a digital unit (not shown).

Antenna 1362 can include one or more antennas, or antenna arrays, configured to send and/or receive wireless signals. Antenna 1362 can be coupled to radio front end circuitry 1390 and can be any type of antenna capable of transmitting and receiving data and/or signals wirelessly. In some embodiments, antenna 1362 can comprise one or more omni-directional, sector or panel antennas operable to transmit/receive radio signals between, for example, 2 GHz and 66 GHz. An omni-directional antenna can be used to transmit/receive radio signals in any direction, a sector antenna can be used to transmit/receive radio signals from devices within a particular area, and a panel antenna can be a line of sight antenna used to transmit/receive radio signals in a relatively straight line. In some instances, the use of more than one antenna can be referred to as MIMO. In certain embodiments, antenna 1362 can be separate from network node 1360 and can be connectable to network node 1360 through an interface or port.

Antenna 1362, interface 1390, and/or processing circuitry 1370 can be configured to perform any receiving operations and/or certain obtaining operations described herein as being performed by a network node. Any information, data and/or signals can be received from a wireless device, another network node and/or any other network equipment. Similarly, antenna 1362, interface 1390, and/or processing circuitry 1370 can be configured to perform any transmitting operations described herein as being performed by a network node. Any information, data and/or signals can be transmitted to a wireless device, another network node and/or any other network equipment.

Power circuitry 1387 can comprise, or be coupled to, power management circuitry and can be configured to supply the components of network node 1360 with power for performing the functionality described herein. Power circuitry 1387 can receive power from power source 1386. Power source 1386 and/or power circuitry 1387 can be configured to provide power to the various components of network node 1360 in a form suitable for the respective components (e.g., at a voltage and current level needed for each respective component). Power source 1386 can either be included in, or external to, power circuitry 1387 and/or network node 1360. For example, network node 1360 can be connectable to an external power source (e.g., an electricity outlet) via an input circuitry or interface such as an electrical cable, whereby the external power source supplies power to power circuitry 1387. As a further example, power source 1386 can comprise a source of power in the form of a battery or battery pack which is connected to, or integrated in, power circuitry 1387. The battery can provide backup power should the external power source fail. Other types of power sources, such as photovoltaic devices, can also be used.

Alternative embodiments of network node 1360 can include additional components beyond those shown in FIG. 13 that can be responsible for providing certain aspects of the network node's functionality, including any of the functionality described herein and/or any functionality necessary to support the subject matter described herein. For example, network node 1360 can include user interface equipment to allow and/or facilitate input of information into network node 1360 and to allow and/or facilitate output of information from network node 1360. This can allow and/or facilitate a user to perform diagnostic, maintenance, repair, and other administrative functions for network node 1360.

As used herein, wireless device (WD) refers to a device capable, configured, arranged and/or operable to communicate wirelessly with network nodes and/or other wireless devices. Unless otherwise noted, the term WD can be used interchangeably herein with user equipment (UE). Communicating wirelessly can involve transmitting and/or receiving wireless signals using electromagnetic waves, radio waves, infrared waves, and/or other types of signals suitable for conveying information through air. In some embodiments, a WD can be configured to transmit and/or receive information without direct human interaction. For instance, a WD can be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc.

A WD can support device-to-device (D2D) communication, for example by implementing a 3GPP standard for sidelink communication, vehicle-to-vehicle (V2V), vehicle-to-infrastructure (V21), vehicle-to-everything (V2X) and can in this case be referred to as a D2D communication device. As yet another specific example, in an Internet of Things (IoT) scenario, a WD can represent a machine or other device that performs monitoring and/or measurements, and transmits the results of such monitoring and/or measurements to another WD and/or a network node. The WD can in this case be a machine-to-machine (M2M) device, which can in a 3GPP context be referred to as an MTC device. As one particular example, the WD can be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD can represent a vehicle or other equipment that is capable of monitoring and/or reporting on its operational status or other functions associated with its operation. A WD as described above can represent the endpoint of a wireless connection, in which case the device can be referred to as a wireless terminal. Furthermore, a WD as described above can be mobile, in which case it can also be referred to as a mobile device or a mobile terminal.

As illustrated, wireless device 1310 includes antenna 1311, interface 1314, processing circuitry 1320, device readable medium 1330, user interface equipment 1332, auxiliary equipment 1334, power source 1336 and power circuitry 1337. WD 1310 can include multiple sets of one or more of the illustrated components for different wireless technologies supported by WD 1310, such as, for example, GSM, WCDMA, LTE, NR, WiFi, WiMAX, or Bluetooth wireless technologies, just to mention a few. These wireless technologies can be integrated into the same or different chips or set of chips as other components within WD 1310.

Antenna 1311 can include one or more antennas or antenna arrays, configured to send and/or receive wireless signals, and is connected to interface 1314. In certain alternative embodiments, antenna 1311 can be separate from WD 1310 and be connectable to WD 1310 through an interface or port. Antenna 1311, interface 1314, and/or processing circuitry 1320 can be configured to perform any receiving or transmitting operations described herein as being performed by a WD. Any information, data and/or signals can be received from a network node and/or another WD. In some embodiments, radio front end circuitry and/or antenna 1311 can be considered an interface.

As illustrated, interface 1314 comprises radio front end circuitry 1312 and antenna 1311. Radio front end circuitry 1312 comprise one or more filters 1318 and amplifiers 1316. Radio front end circuitry 1314 is connected to antenna 1311 and processing circuitry 1320 and can be configured to condition signals communicated between antenna 1311 and processing circuitry 1320. Radio front end circuitry 1312 can be coupled to or a part of antenna 1311. In some embodiments, WD 1310 may not include separate radio front end circuitry 1312; rather, processing circuitry 1320 can comprise radio front end circuitry and can be connected to antenna 1311. Similarly, in some embodiments, some or all of RF transceiver circuitry 1322 can be considered a part of interface 1314. Radio front end circuitry 1312 can receive digital data that is to be sent out to other network nodes or WDs via a wireless connection. Radio front end circuitry 1312 can convert the digital data into a radio signal having the appropriate channel and bandwidth parameters using a combination of filters 1318 and/or amplifiers 1316. The radio signal can then be transmitted via antenna 1311. Similarly, when receiving data, antenna 1311 can collect radio signals which are then converted into digital data by radio front end circuitry 1312. The digital data can be passed to processing circuitry 1320. In other embodiments, the interface can comprise different components and/or different combinations of components.

Processing circuitry 1320 can comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 1310 components, such as device readable medium 1330, WD 1310 functionality. Such functionality can include providing any of the various wireless features or benefits discussed herein. For example, processing circuitry 1320 can execute instructions stored in device readable medium 1330 or in memory within processing circuitry 1320 to provide the functionality disclosed herein.

As illustrated, processing circuitry 1320 includes one or more of RF transceiver circuitry 1322, baseband processing circuitry 1324, and application processing circuitry 1326. In other embodiments, the processing circuitry can comprise different components and/or different combinations of components. In certain embodiments processing circuitry 1320 of WD 1310 can comprise a SOC. In some embodiments, RF transceiver circuitry 1322, baseband processing circuitry 1324, and application processing circuitry 1326 can be on separate chips or sets of chips. In alternative embodiments, part or all of baseband processing circuitry 1324 and application processing circuitry 1326 can be combined into one chip or set of chips, and RF transceiver circuitry 1322 can be on a separate chip or set of chips. In still alternative embodiments, part or all of RF transceiver circuitry 1322 and baseband processing circuitry 1324 can be on the same chip or set of chips, and application processing circuitry 1326 can be on a separate chip or set of chips. In yet other alternative embodiments, part or all of RF transceiver circuitry 1322, baseband processing circuitry 1324, and application processing circuitry 1326 can be combined in the same chip or set of chips. In some embodiments, RF transceiver circuitry 1322 can be a part of interface 1314. RF transceiver circuitry 1322 can condition RF signals for processing circuitry 1320.

In certain embodiments, some or all of the functionality described herein as being performed by a WD can be provided by processing circuitry 1320 executing instructions stored on device readable medium 1330, which in certain embodiments can be a computer-readable storage medium. In alternative embodiments, some or all of the functionality can be provided by processing circuitry 1320 without executing instructions stored on a separate or discrete device readable storage medium, such as in a hard-wired manner. In any of those particular embodiments, whether executing instructions stored on a device readable storage medium or not, processing circuitry 1320 can be configured to perform the described functionality. The benefits provided by such functionality are not limited to processing circuitry 1320 alone or to other components of WD 1310, but are enjoyed by WD 1310 as a whole, and/or by end users and the wireless network generally.

Processing circuitry 1320 can be configured to perform any determining, calculating, or similar operations (e.g., certain obtaining operations) described herein as being performed by a WD. These operations, as performed by processing circuitry 1320, can include processing information obtained by processing circuitry 1320 by, for example, converting the obtained information into other information, comparing the obtained information or converted information to information stored by WD 1310, and/or performing one or more operations based on the obtained information or converted information, and as a result of said processing making a determination.

Device readable medium 1330 can be operable to store a computer program, software, an application including one or more of logic, rules, code, tables, etc. and/or other instructions capable of being executed by processing circuitry 1320. Device readable medium 1330 can include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that can be used by processing circuitry 1320. In some embodiments, processing circuitry 1320 and device readable medium 1330 can be considered to be integrated.

User interface equipment 1332 can include components that allow and/or facilitate a human user to interact with WD 1310. Such interaction can be of many forms, such as visual, audial, tactile, etc. User interface equipment 1332 can be operable to produce output to the user and to allow and/or facilitate the user to provide input to WD 1310. The type of interaction can vary depending on the type of user interface equipment 1332 installed in WD 1310. For example, if WD 1310 is a smart phone, the interaction can be via a touch screen; if WD 1310 is a smart meter, the interaction can be through a screen that provides usage (e.g., the number of gallons used) or a speaker that provides an audible alert (e.g., if smoke is detected). User interface equipment 1332 can include input interfaces, devices and circuits, and output interfaces, devices and circuits. User interface equipment 1332 can be configured to allow and/or facilitate input of information into WD 1310 and is connected to processing circuitry 1320 to allow and/or facilitate processing circuitry 1320 to process the input information. User interface equipment 1332 can include, for example, a microphone, a proximity or other sensor, keys/buttons, a touch display, one or more cameras, a USB port, or other input circuitry. User interface equipment 1332 is also configured to allow and/or facilitate output of information from WD 1310, and to allow and/or facilitate processing circuitry 1320 to output information from WD 1310. User interface equipment 1332 can include, for example, a speaker, a display, vibrating circuitry, a USB port, a headphone interface, or other output circuitry. Using one or more input and output interfaces, devices, and circuits, of user interface equipment 1332, WD 1310 can communicate with end users and/or the wireless network and allow and/or facilitate them to benefit from the functionality described herein.

Auxiliary equipment 1334 is operable to provide more specific functionality which may not be generally performed by WDs. This can comprise specialized sensors for doing measurements for various purposes, interfaces for additional types of communication such as wired communications etc. The inclusion and type of components of auxiliary equipment 1334 can vary depending on the embodiment and/or scenario.

Power source 1336 can, in some embodiments, be in the form of a battery or battery pack. Other types of power sources, such as an external power source (e.g., an electricity outlet), photovoltaic devices or power cells, can also be used. WD 1310 can further comprise power circuitry 1337 for delivering power from power source 1336 to the various parts of WD 1310 which need power from power source 1336 to carry out any functionality described or indicated herein. Power circuitry 1337 can in certain embodiments comprise power management circuitry. Power circuitry 1337 can additionally or alternatively be operable to receive power from an external power source; in which case WD 1310 can be connectable to the external power source (such as an electricity outlet) via input circuitry or an interface such as an electrical power cable. Power circuitry 1337 can also in certain embodiments be operable to deliver power from an external power source to power source 1336. This can be, for example, for the charging of power source 1336. Power circuitry 1337 can perform any converting or other modification to the power from power source 1336 to make it suitable for supply to the respective components of WD 1310.

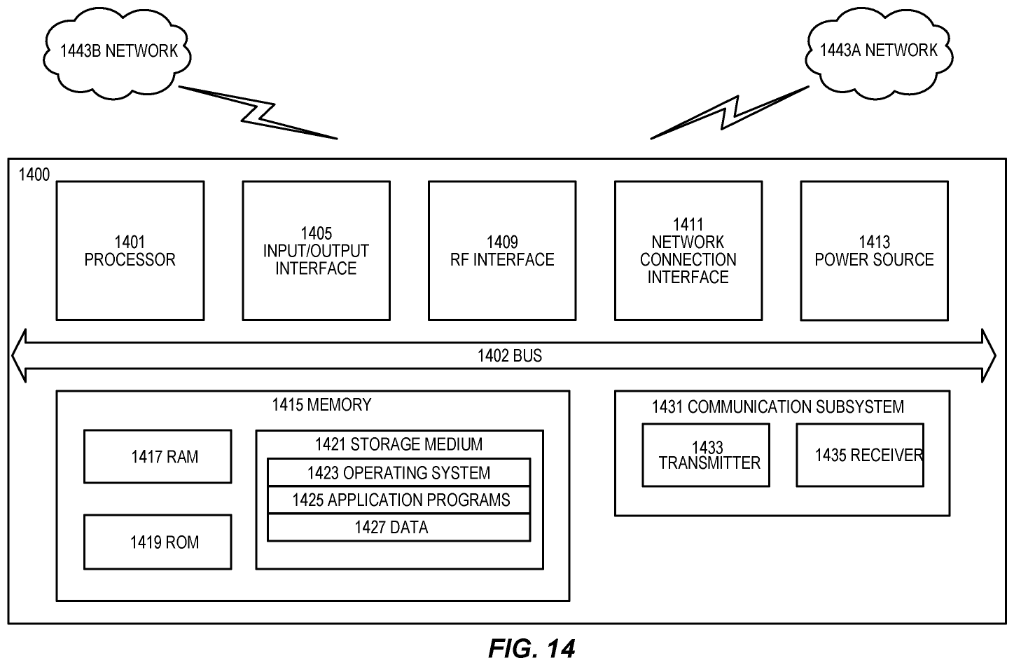

FIG. 14 illustrates one embodiment of a UE in accordance with various aspects described herein. As used herein, a user equipment or UE may not necessarily have a user in the sense of a human user who owns and/or operates the relevant device. Instead, a UE can represent a device that is intended for sale to, or operation by, a human user but which may not, or which may not initially, be associated with a specific human user (e.g., a smart sprinkler controller). Alternatively, a UE can represent a device that is not intended for sale to, or operation by, an end user but which can be associated with or operated for the benefit of a user (e.g., a smart power meter). UE 1400 can be any UE identified by the 3rd Generation Partnership Project (3GPP), including a NB-IoT UE, a machine type communication (MTC) UE, and/or an enhanced MTC (eMTC) UE. UE 1400, as illustrated in FIG. 14, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE can be used interchangeable.

Accordingly, although FIG. 14 is a UE, the components discussed herein are equally applicable to a WD, and vice-versa.

In FIG. 14, UE 1400 includes processing circuitry 1401 that is operatively coupled to input/output interface 1405, radio frequency (RF) interface 1409, network connection interface 1411, memory 1415 including random access memory (RAM) 1417, read-only memory (ROM) 1419, and storage medium 1421 or the like, communication subsystem 1431, power source 1413, and/or any other component, or any combination thereof. Storage medium 1421 includes operating system 1423, application program 1425, and data 1427. In other embodiments, storage medium 1421 can include other similar types of information. Certain UEs can utilize all of the components shown in FIG. 14, or only a subset of the components. The level of integration between the components can vary from one UE to another UE. Further, certain UEs can contain multiple instances of a component, such as multiple processors, memories, transceivers, transmitters, receivers, etc.

In FIG. 14, processing circuitry 1401 can be configured to process computer instructions and data. Processing circuitry 1401 can be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1401 can include two central processing units (CPUs). Data can be information in a form suitable for use by a computer.

In the depicted embodiment, input/output interface 1405 can be configured to provide a communication interface to an input device, output device, or input and output device. UE 1400 can be configured to use an output device via input/output interface 1405. An output device can use the same type of interface port as an input device. For example, a USB port can be used to provide input to and output from UE 1400. The output device can be a speaker, a sound card, a video card, a display, a monitor, a printer, an actuator, an emitter, a smartcard, another output device, or any combination thereof. UE 1400 can be configured to use an input device via input/output interface 1405 to allow and/or facilitate a user to capture information into UE 1400. The input device can include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display can include a capacitive or resistive touch sensor to sense input from a user. A sensor can be, for instance, an accelerometer, a gyroscope, a tilt sensor, a force sensor, a magnetometer, an optical sensor, a proximity sensor, another like sensor, or any combination thereof. For example, the input device can be an accelerometer, a magnetometer, a digital camera, a microphone, and an optical sensor.

In FIG. 14, RF interface 1409 can be configured to provide a communication interface to RF components such as a transmitter, a receiver, and an antenna. Network connection interface 1411 can be configured to provide a communication interface to network 1443A. Network 1443a can encompass wired and/or wireless networks such as a local-area network (LAN), a wide-area network (WAN), a computer network, a wireless network, a telecommunications network, another like network or any combination thereof. For example, network 1443A can comprise a Wi-Fi network. Network connection interface 1411 can be configured to include a receiver and a transmitter interface used to communicate with one or more other devices over a communication network according to one or more communication protocols, such as Ethernet, TCP/IP, SONET, ATM, or the like. Network connection interface 1411 can implement receiver and transmitter functionality appropriate to the communication network links (e.g., optical, electrical, and the like). The transmitter and receiver functions can share circuit components, software or firmware, or alternatively can be implemented separately.

RAM 1417 can be configured to interface via bus 1402 to processing circuitry 1401 to provide storage or caching of data or computer instructions during the execution of software programs such as the operating system, application programs, and device drivers. ROM 1419 can be configured to provide computer instructions or data to processing circuitry 1401. For example, ROM 1419 can be configured to store invariant low-level system code or data for basic system functions such as basic input and output (I/O), startup, or reception of keystrokes from a keyboard that are stored in a non-volatile memory. Storage medium 1421 can be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1421 can be configured to include operating system 1423, application program 1425 such as a web browser application, a widget or gadget engine or another application, and data file 1427. Storage medium 1421 can store, for use by UE 1400, any of a variety of various operating systems or combinations of operating systems.

Storage medium 1421 can be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1421 can allow and/or facilitate UE 1400 to access computer-executable instructions, application programs or the like, stored on transitory or non-transitory memory media, to off-load data, or to upload data. An article of manufacture, such as one utilizing a communication system can be tangibly embodied in storage medium 1421, which can comprise a device readable medium.

In FIG. 14, processing circuitry 1401 can be configured to communicate with network 1443B using communication subsystem 1431. Network 1443A and network 1443Bcan be the same network or networks or different network or networks. Communication subsystem 1431 can be configured to include one or more transceivers used to communicate with network 1443B. For example, communication subsystem 1431 can be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver can include transmitter 1433 and/or receiver 1435 to implement transmitter or receiver functionality, respectively, appropriate to the RAN links (e.g., frequency allocations and the like). Further, transmitter 1433 and receiver 1435 of each transceiver can share circuit components, software or firmware, or alternatively can be implemented separately.

In the illustrated embodiment, the communication functions of communication subsystem 1431 can include data communication, voice communication, multimedia communication, short-range communications such as Bluetooth, near-field communication, location-based communication such as the use of the global positioning system (GPS) to determine a location, another like communication function, or any combination thereof. For example, communication subsystem 1431 can include cellular communication, Wi-Fi communication, Bluetooth communication, and GPS communication. Network 1443B can encompass wired and/or wireless networks such as a local-area network (LAN), a wide-area network (WAN), a computer network, a wireless network, a telecommunications network, another like network or any combination thereof. For example, network 1443B can be a cellular network, a Wi-Fi network, and/or a near-field network. Power source 1413 can be configured to provide alternating current (AC) or direct current (DC) power to components of UE 1400.

The features, benefits and/or functions described herein can be implemented in one of the components of UE 1400 or partitioned across multiple components of UE 1400. Further, the features, benefits, and/or functions described herein can be implemented in any combination of hardware, software or firmware. In one example, communication subsystem 1431 can be configured to include any of the components described herein. Further, processing circuitry 1401 can be configured to communicate with any of such components over bus 1402. In another example, any of such components can be represented by program instructions stored in memory that when executed by processing circuitry 1401 perform the corresponding functions described herein. In another example, the functionality of any of such components can be partitioned between processing circuitry 1401 and communication subsystem 1431. In another example, the non-computationally intensive functions of any of such components can be implemented in software or firmware and the computationally intensive functions can be implemented in hardware.

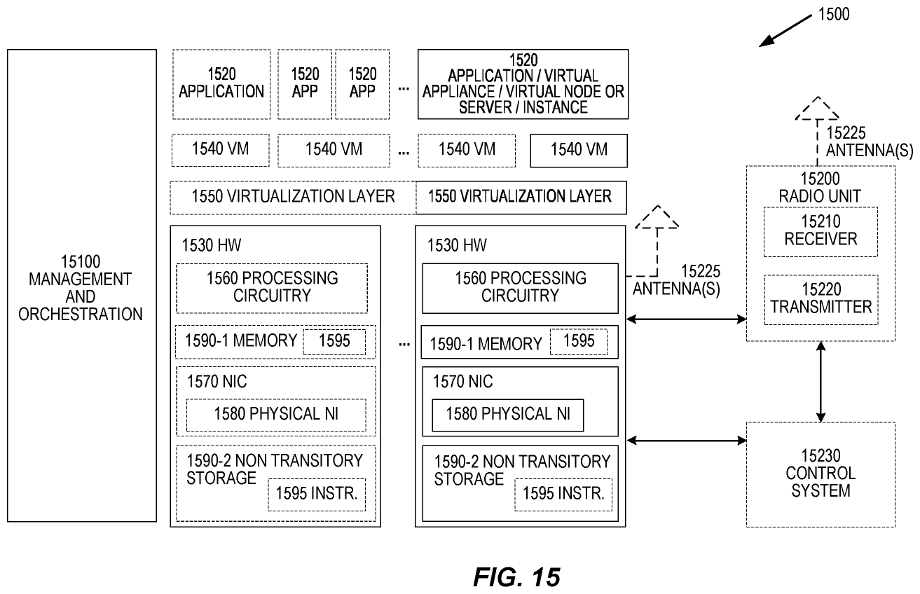

FIG. 15 is a schematic block diagram illustrating a virtualization environment 1500 in which functions implemented by some embodiments can be virtualized. In the present context, virtualizing means creating virtual versions of apparatuses or devices which can include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein can be implemented as virtual components executed by one or more virtual machines implemented in one or more virtual environments 1500 hosted by one or more of hardware nodes 1530. Further, in embodiments in which the virtual node is not a radio access node or does not require radio connectivity (e.g., a core network node), then the network node can be entirely virtualized.

The functions can be implemented by one or more applications 1520 (which can alternatively be called software instances, virtual appliances, network functions, virtual nodes, virtual network functions, etc.) operative to implement some of the features, functions, and/or benefits of some of the embodiments disclosed herein. Applications 1520 are run in virtualization environment 1500 which provides hardware 1530 comprising processing circuitry 1560 and memory 1590. Memory 1590 contains instructions 1595 executable by processing circuitry 1560 whereby application 1520 is operative to provide one or more of the features, benefits, and/or functions disclosed herein.

Virtualization environment 1500 comprises general-purpose or special-purpose network hardware devices 1530 comprising a set of one or more processors or processing circuitry 1560, which can be commercial off-the-shelf (COTS) processors, dedicated Application Specific Integrated Circuits (ASICs), or any other type of processing circuitry including digital or analog hardware components or special purpose processors. Each hardware device can comprise memory 1590-1 which can be non-persistent memory for temporarily storing instructions 1595 or software executed by processing circuitry 1560. Each hardware device can comprise one or more network interface controllers (NICs) 1570, also known as network interface cards, which include physical network interface 1580. Each hardware device can also include non-transitory, persistent, machine-readable storage media 1590-2 having stored therein software 1595 and/or instructions executable by processing circuitry 1560. Software 1595 can include any type of software including software for instantiating one or more virtualization layers 1550 (also referred to as hypervisors), software to execute virtual machines 1540 as well as software allowing it to execute functions, features and/or benefits described in relation with some embodiments described herein.

Virtual machines 1540, comprise virtual processing, virtual memory, virtual networking or interface and virtual storage, and can be run by a corresponding virtualization layer 1550 or hypervisor. Different embodiments of the instance of virtual appliance 1520 can be implemented on one or more of virtual machines 1540, and the implementations can be made in different ways.

During operation, processing circuitry 1560 executes software 1595 to instantiate the hypervisor or virtualization layer 1550, which can sometimes be referred to as a virtual machine monitor

(VMM). Virtualization layer 1550 can present a virtual operating platform that appears like networking hardware to virtual machine 1540.

As shown in FIG. 15, hardware 1530 can be a standalone network node with generic or specific components. Hardware 1530 can comprise antenna 15225 and can implement some functions via virtualization. Alternatively, hardware 1530 can be part of a larger cluster of hardware (e.g. such as in a data center or customer premise equipment (CPE)) where many hardware nodes work together and are managed via management and orchestration (MANO) 15100, which, among others, oversees lifecycle management of applications 1520.

Virtualization of the hardware is in some contexts referred to as network function virtualization (NFV). NFV can be used to consolidate many network equipment types onto industry standard high-volume server hardware, physical switches, and physical storage, which can be located in data centers, and customer premise equipment.

In the context of NFV, virtual machine 1540 can be a software implementation of a physical machine that runs programs as if they were executing on a physical, non-virtualized machine. Each of virtual machines 1540, and that part of hardware 1530 that executes that virtual machine, be it hardware dedicated to that virtual machine and/or hardware shared by that virtual machine with others of the virtual machines 1540, forms a separate virtual network elements (VNE).

Still in the context of NFV, Virtual Network Function (VNF) is responsible for handling specific network functions that run in one or more virtual machines 1540 on top of hardware networking infrastructure 1530 and corresponds to application 1520 in FIG. 15.

In some embodiments, one or more radio units 15200 that each include one or more transmitters 15220 and one or more receivers 15210 can be coupled to one or more antennas 15225. Radio units 15200 can communicate directly with hardware nodes 1530 via one or more appropriate network interfaces and can be used in combination with the virtual components to provide a virtual node with radio capabilities, such as a radio access node or a base station.

In some embodiments, some signaling can be effected with the use of control system 15230 which can alternatively be used for communication between the hardware nodes 1530 and radio units 15200.

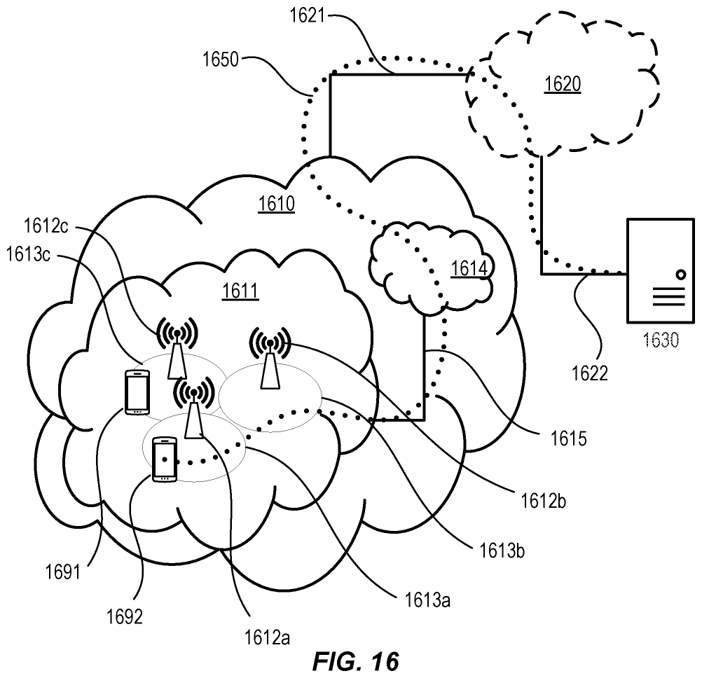

With reference to FIG. 16, in accordance with an embodiment, a communication system includes telecommunication network 1610, such as a 3GPP-type cellular network, which comprises access network 1611, such as a radio access network, and core network 1614.

Access network 1611 comprises a plurality of base stations 1612a, 1612b, 1612c, such as NBs, eNBs, gNBs or other types of wireless access points, each defining a corresponding coverage area 1613a, 1613b, 1613c. Each base station 1612a, 1612b, 1612c is connectable to core network 1614 over a wired or wireless connection 1615. A first UE 1691 located in coverage area 1613c can be configured to wirelessly connect to, or be paged by, the corresponding base station 1612c. A second UE 1692 in coverage area 1613a is wirelessly connectable to the corresponding base station 1612a. While a plurality of UEs 1691, 1692 are illustrated in this example, the disclosed embodiments are equally applicable to a situation where a sole UE is in the coverage area or where a sole UE is connecting to the corresponding base station 1612.

Telecommunication network 1610 is itself connected to host computer 1630, which can be embodied in the hardware and/or software of a standalone server, a cloud-implemented server, a distributed server or as processing resources in a server farm. Host computer 1630 can be under the ownership or control of a service provider or can be operated by the service provider or on behalf of the service provider. Connections 1621 and 1622 between telecommunication network 1610 and host computer 1630 can extend directly from core network 1614 to host computer 1630 or can go via an optional intermediate network 1620. Intermediate network 1620 can be one of, or a combination of more than one of, a public, private or hosted network; intermediate network 1620, if any, can be a backbone network or the Internet; in particular, intermediate network 1620 can comprise two or more sub-networks (not shown).

The communication system of FIG. 16 as a whole enables connectivity between the connected UEs 1691, 1692 and host computer 1630. The connectivity can be described as an over-the-top (OTT) connection 1650. Host computer 1630 and the connected UEs 1691, 1692 are configured to communicate data and/or signaling via OTT connection 1650, using access network 1611, core network 1614, any intermediate network 1620 and possible further infrastructure (not shown) as intermediaries. OTT connection 1650 can be transparent in the sense that the participating communication devices through which OTT connection 1650 passes are unaware of routing of uplink and downlink communications. For example, base station 1612 may not or need not be informed about the past routing of an incoming downlink communication with data originating from host computer 1630 to be forwarded (e.g., handed over) to a connected UE 1691. Similarly, base station 1612 need not be aware of the future routing of an outgoing uplink communication originating from the UE 1691 towards the host computer 1630.

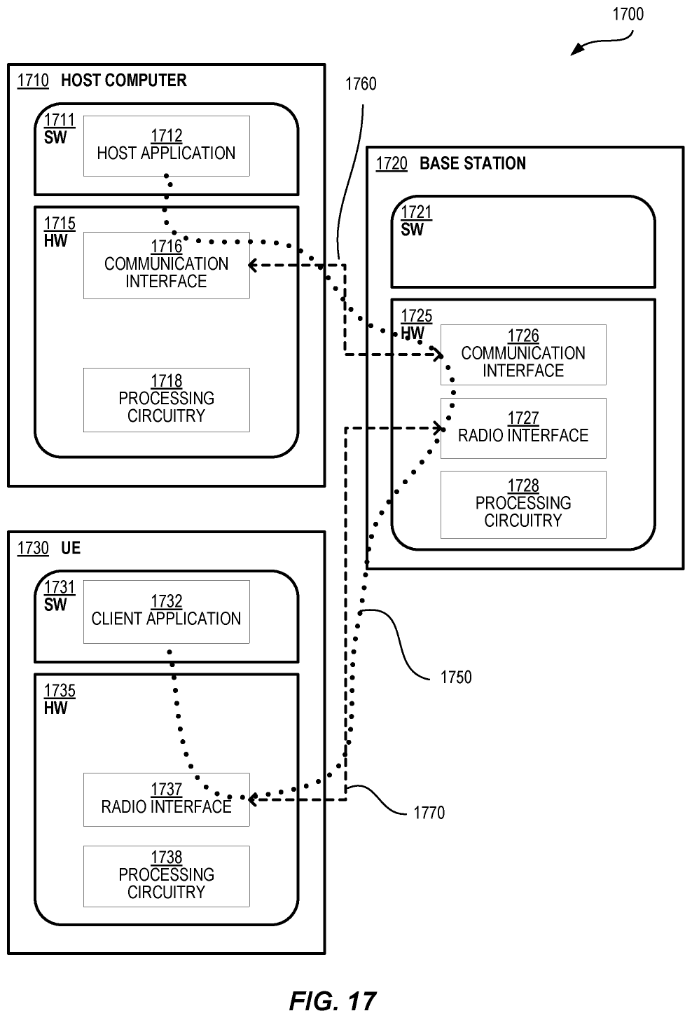

Example implementations, in accordance with an embodiment, of the UE, base station and host computer discussed in the preceding paragraphs will now be described with reference to FIG. 17. In communication system 1700, host computer 1710 comprises hardware 1715 including communication interface 1716 configured to set up and maintain a wired or wireless connection with an interface of a different communication device of communication system 1700. Host computer 1710 further comprises processing circuitry 1718, which can have storage and/or processing capabilities. In particular, processing circuitry 1718 can comprise one or more programmable processors, application-specific integrated circuits, field programmable gate arrays or combinations of these (not shown) adapted to execute instructions. Host computer 1710 further comprises software 1711, which is stored in or accessible by host computer 1710 and executable by processing circuitry 1718. Software 1711 includes host application 1712. Host application 1712 can be operable to provide a service to a remote user, such as UE 1730 connecting via OTT connection 1750 terminating at UE 1730 and host computer 1710. In providing the service to the remote user, host application 1712 can provide user data which is transmitted using OTT connection 1750.

Communication system 1700 can also include base station 1720 provided in a telecommunication system and comprising hardware 1714 enabling it to communicate with host computer 1710 and with UE 1730. Hardware 1714 can include communication interface 1726 for setting up and maintaining a wired or wireless connection with an interface of a different communication device of communication system 1700, as well as radio interface 1727 for setting up and maintaining at least wireless connection 1770 with UE 1730 located in a coverage area (not shown in FIG. 17) served by base station 1720. Communication interface 1726 can be configured to facilitate connection 1760 to host computer 1710. Connection 1760 can be direct, or it can pass through a core network (not shown in FIG. 17) of the telecommunication system and/or through one or more intermediate networks outside the telecommunication system. In the embodiment shown, hardware 1714 of base station 1720 can also include processing circuitry 1728, which can comprise one or more programmable processors, application-specific integrated circuits, field programmable gate arrays or combinations of these (not shown) adapted to execute instructions. Base station 1720 further has software 1721 stored internally or accessible via an external connection.

Communication system 1700 can also include UE 1730 already referred to. Its hardware 1735 can include radio interface 1737 configured to set up and maintain wireless connection 1770 with a base station serving a coverage area in which UE 1730 is currently located. Hardware 1735 of UE 1730 can also include processing circuitry 1738, which can comprise one or more programmable processors, application-specific integrated circuits, field programmable gate arrays or combinations of these (not shown) adapted to execute instructions. UE 1730 further comprises software 1731, which is stored in or accessible by UE 1730 and executable by processing circuitry 1738. Software 1731 includes client application 1732. Client application 1732 can be operable to provide a service to a human or non-human user via UE 1730, with the support of host computer 1710. In host computer 1710, an executing host application 1712 can communicate with the executing client application 1732 via OTT connection 1750 terminating at UE 1730 and host computer 1710. In providing the service to the user, client application 1732 can receive request data from host application 1712 and provide user data in response to the request data. OTT connection 1750 can transfer both the request data and the user data. Client application 1732 can interact with the user to generate the user data that it provides.

It is noted that host computer 1710, base station 1720 and UE 1730 illustrated in FIG. 17 can be similar or identical to host computer 1630, one of base stations 1612a, 1612b, 1612c and one of UEs 1691, 1692 of FIG. 16, respectively. This is to say, the inner workings of these entities can be as shown in FIG. 17 and independently, the surrounding network topology can be that of FIG. 16.

In FIG. 17, OTT connection 1750 has been drawn abstractly to illustrate the communication between host computer 1710 and UE 1730 via base station 1720, without explicit reference to any intermediary devices and the precise routing of messages via these devices. Network infrastructure can determine the routing, which it can be configured to hide from UE 1730 or from the service provider operating host computer 1710, or both. While OTT connection 1750 is active, the network infrastructure can further take decisions by which it dynamically changes the routing (e.g., on the basis of load balancing consideration or reconfiguration of the network).

Wireless connection 1770 between UE 1730 and base station 1720 is in accordance with the teachings of the embodiments described throughout this disclosure. One or more of the various embodiments improve the performance of OTT services provided to UE 1730 using OTT connection 1750, in which wireless connection 1770 forms the last segment. More precisely, the exemplary embodiments disclosed herein enable multiple MT entities (either logical or physical) to be made available at the IAB node. This way, the LCID space is expanded to the desired level of QoS differentiation, and other possibilities arise such as load balancing, dual connectivity and robust path change. This ensures good performance for all users even in situations where the UEs are unevenly distributed between IAB nodes (e.g., some IAB nodes serve many UEs and should therefore get relatively more resources on the wireless backhaul interface). The IAB network will be more scalable in terms of number of hops/IAB nodes. For example, without the embodiments described herein, there could be a bottleneck limiting the performance for IAB nodes serving many other IAB nodes. These and other advantages can faciltate more timely design, implementation, and deployment of 5G/NR solutions. Furthermore, such embodiments can facilitate flexible and timely control of data session QoS, which can lead to improvements in capacity, throughput, latency, etc. that are envisioned by 5G/NR and important for the growth of OTT services.

A measurement procedure can be provided for the purpose of monitoring data rate, latency and other network operational aspects on which the one or more embodiments improve. There can further be an optional network functionality for reconfiguring OTT connection 1750 between host computer 1710 and UE 1730, in response to variations in the measurement results. The measurement procedure and/or the network functionality for reconfiguring OTT connection 1750 can be implemented in software 1711 and hardware 1715 of host computer 1710 or in software 1731 and hardware 1735 of UE 1730, or both. In embodiments, sensors (not shown) can be deployed in or in association with communication devices through which OTT connection 1750 passes; the sensors can participate in the measurement procedure by supplying values of the monitored quantities exemplified above or supplying values of other physical quantities from which software 1711, 1731 can compute or estimate the monitored quantities. The reconfiguring of OTT connection 1750 can include message format, retransmission settings, preferred routing etc.; the reconfiguring need not affect base station 1720, and it can be unknown or imperceptible to base station 1720. Such procedures and functionalities can be known and practiced in the art. In certain embodiments, measurements can involve proprietary UE signaling facilitating host computer 1710's measurements of throughput, propagation times, latency and the like. The measurements can be implemented in that software 1711 and 1731 causes messages to be transmitted, in particular empty or ‘dummy’ messages, using OTT connection 1750 while it monitors propagation times, errors etc.

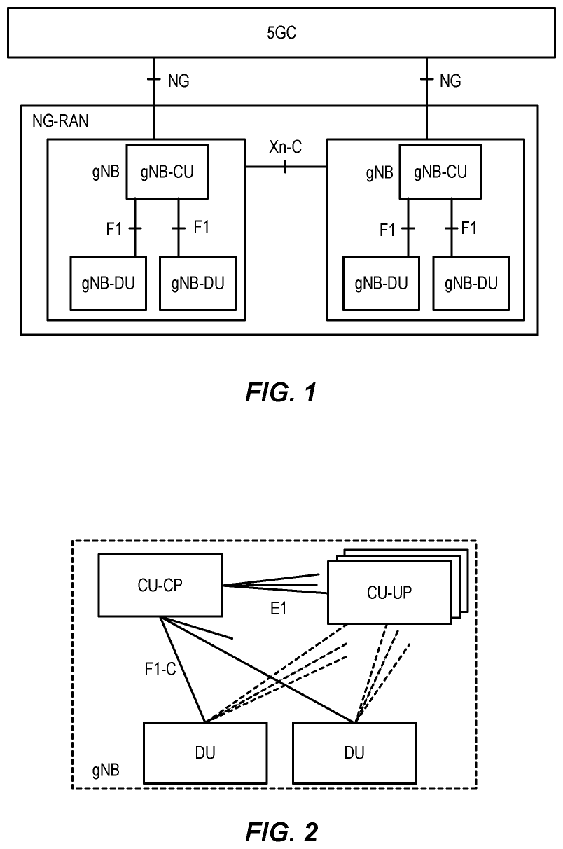

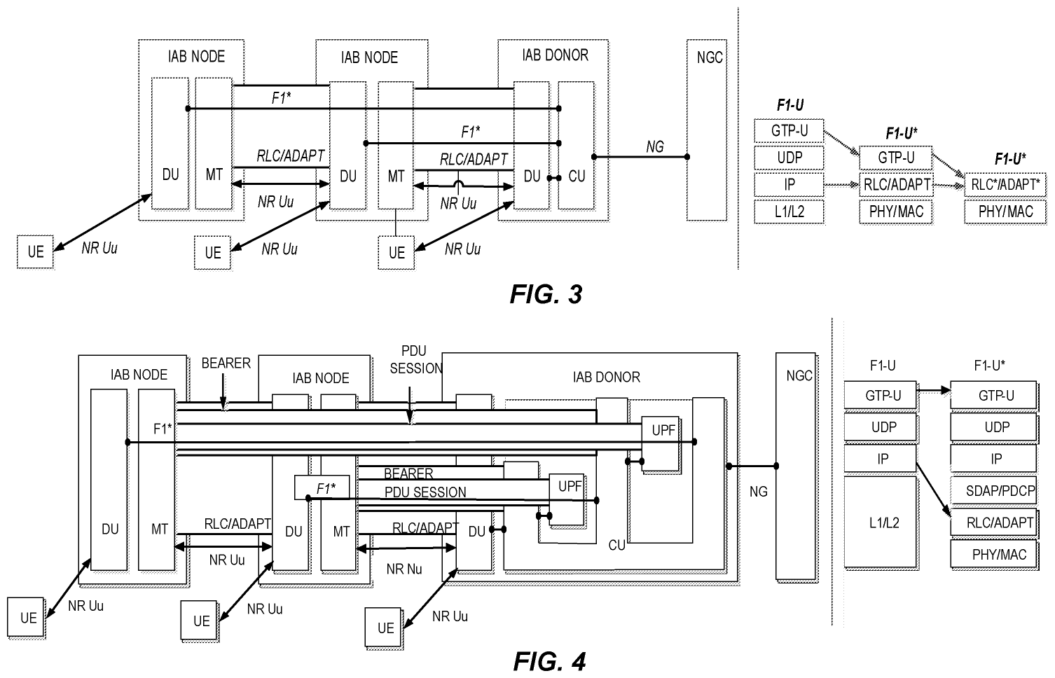

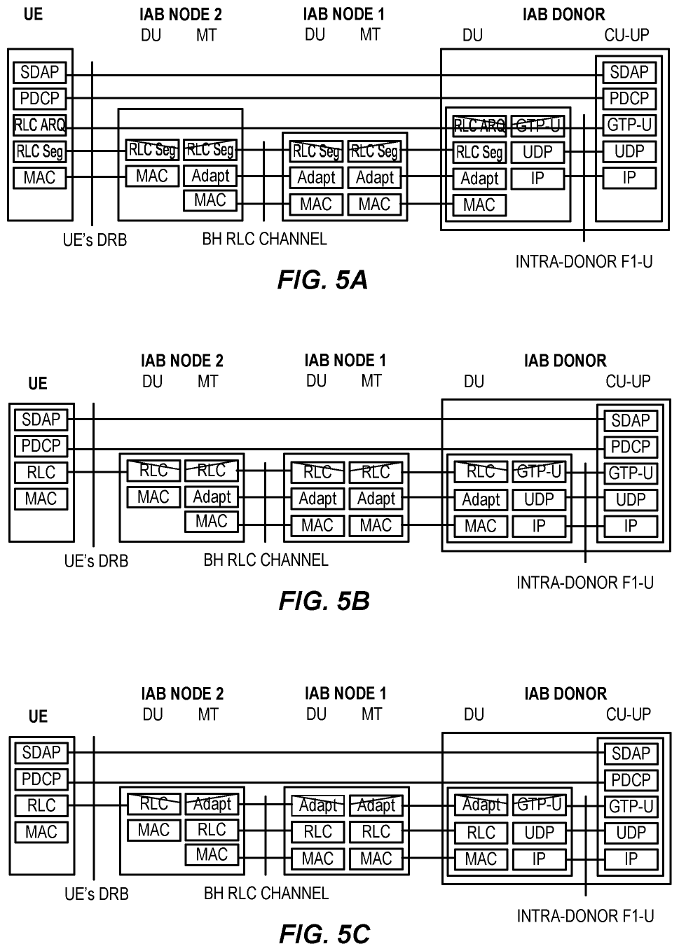

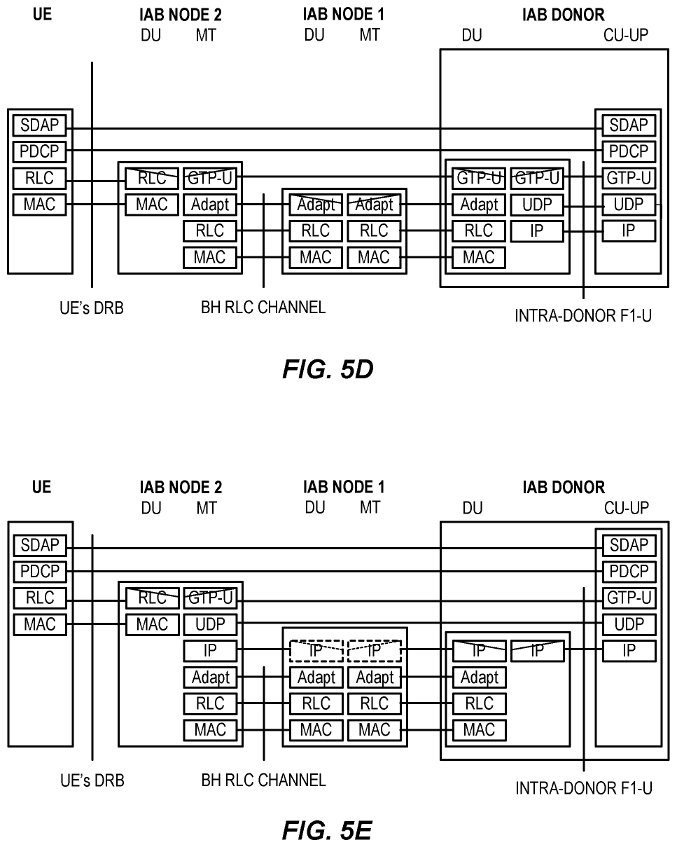

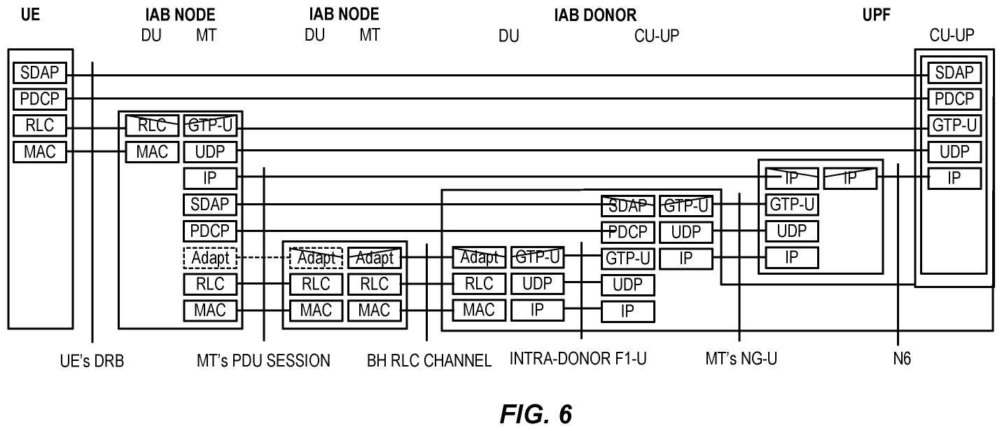

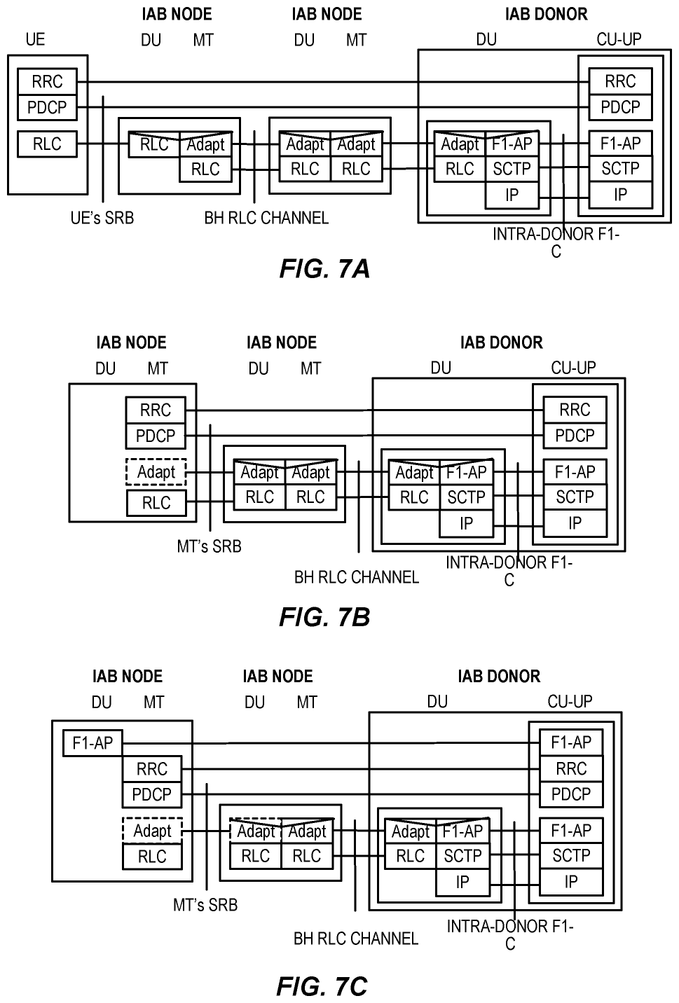

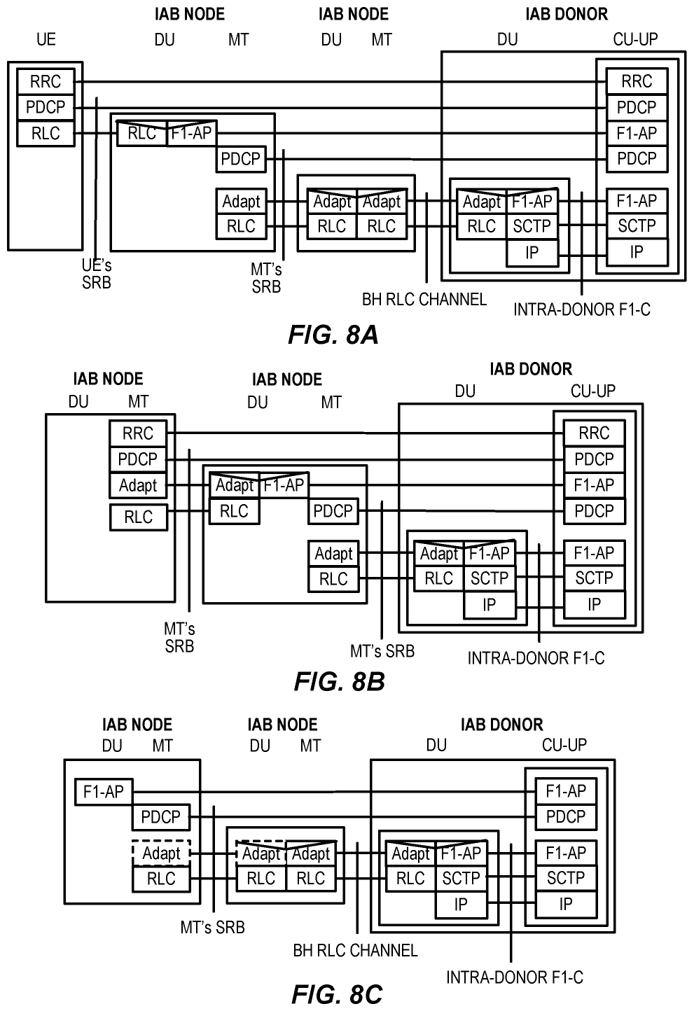

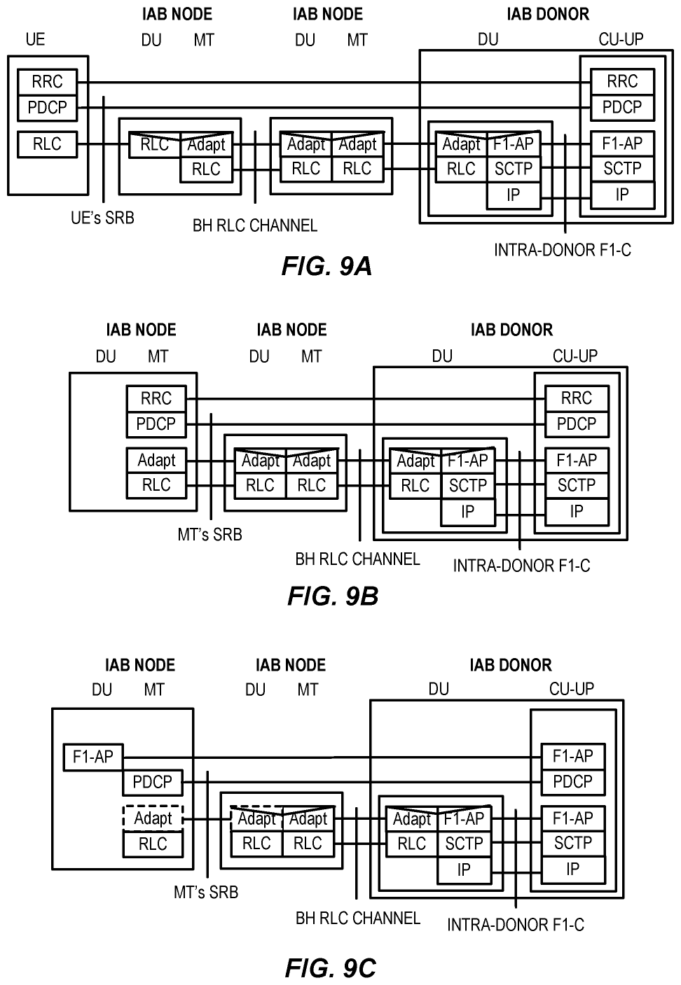

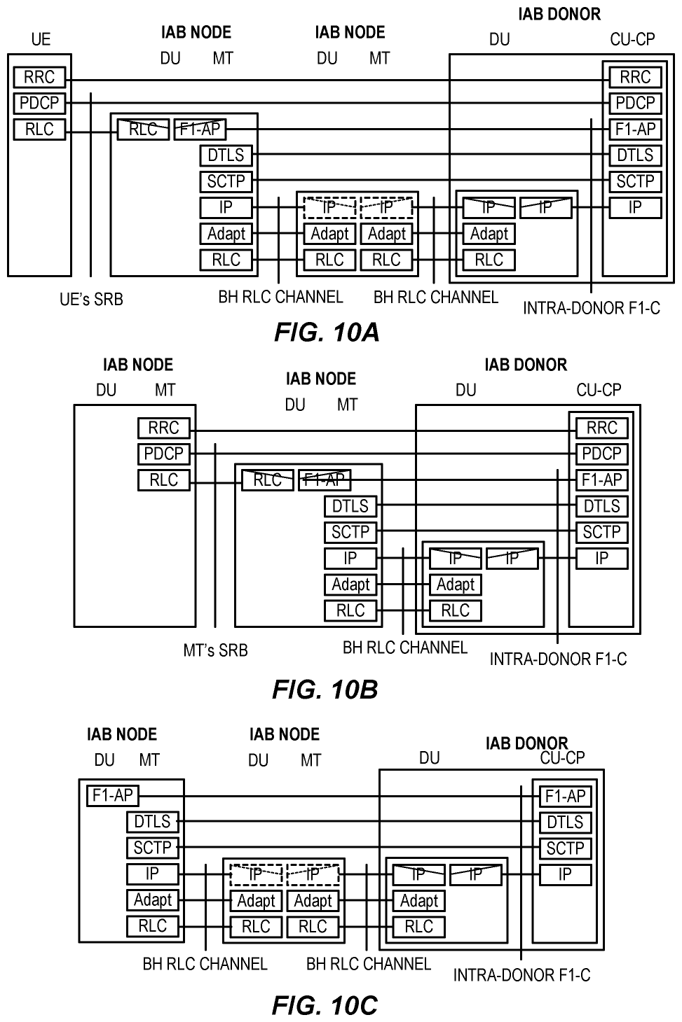

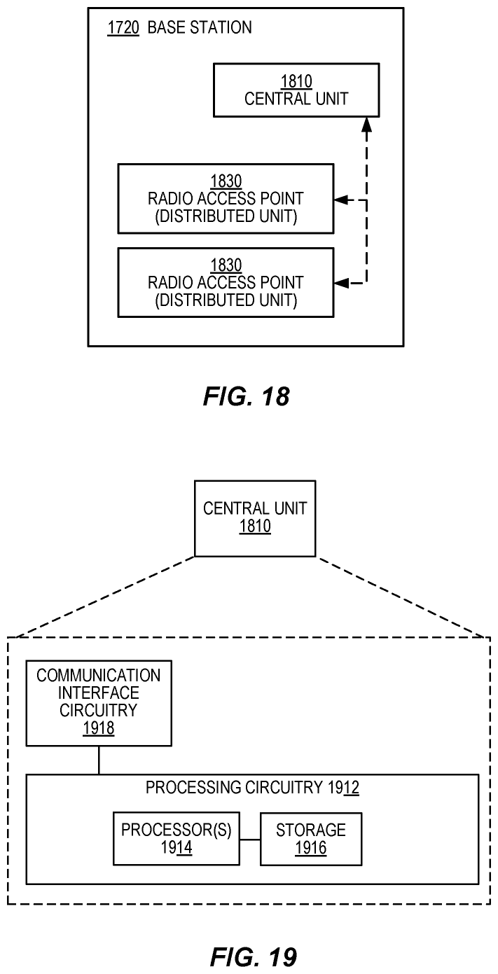

In some exemplary embodiments, the base station 1720 in FIG. 17 comprises the distributed architecture of 5G, such as reflected in FIGS. 1 and 2. For example, FIG. 18 below shows the base station 1720 with a central unit 1810 (e.g., gNB-CU) and at least one distributed unit 1830 (e.g., gNB-DUs).

The base station 1720 may be a donor gNB in some exemplary embodiments, with an F1 interface defined between the central unit 1810 and each of the distributed units 1830 for configuring an adaptation layer for communicating with a relay node through a distributed unit 1830 of the donor base station. The central unit 1810 may have processing circuitry configured, for example, to use RRC signaling to establish a PDU session for an MT part of the relay node and, after establishing the PDU session, configure an F1 adaptation layer in a protocol stack for the MT part of the relay node, the F1 adaptation layer providing for F1 signaling between the central unit of the donor base station and the relay node. The processing circuitry may also be configured to, after configuring the F1 adaptation layer for the MT part of the relay node, set up an F1 adaptation layer for a distributed unit part of the relay node, for communication with a first further relay node downstream of the relay node, using F1 signaling with the relay node, the F1 adaptation layer for the distributed unit part of the relay node being configured to forward packets exchanged between the central unit of the donor base station and the first further relay node.

FIG. 19 illustrates an exemplary embodiment of a central unit 1810. The central unit 1810 may be part of a base station, such as a donor gNB. The central unit 1810 (e.g., gNB-CU) may be connected to and control radio access points, or distributed units (e.g., gNB-DUs). The central unit 1810 may include communication circuitry 1918 for communicating with radio access points (e.g., gNB-DUs 1830) and with other equipment in the core network (e.g., 5GC).

The central unit 1810 may include processing circuitry 1912 that is operatively associated with the communication circuitry 1918. In an example embodiment, the processing circuitry 1912 comprises one or more digital processors 1914, e.g., one or more microprocessors, microcontrollers, Digital Signal Processors (DSPs), Field Programmable Gate Arrays (FPGAs), Complex Programmable Logic Devices (CPLDs), Application Specific Integrated Circuits (ASICs), or any mix thereof. More generally, the processing circuitry 1912 may comprise fixed circuitry, or programmable circuitry that is specially configured via the execution of program instructions implementing the functionality taught herein.

The processing circuitry 1912 also includes or is associated with storage 1916. The storage 1916, in some embodiments, stores one or more computer programs and, optionally, configuration data. The storage 1916 provides non-transitory storage for the computer program and it may comprise one or more types of computer-readable media, such as disk storage, solid-state memory storage, or any mix thereof. By way of non-limiting example, the storage 1916 comprises any one or more of SRAM, DRAM, EEPROM, and FLASH memory.

In general, the storage 1916 comprises one or more types of computer-readable storage media providing non-transitory storage of the computer program and any configuration data used by the base station. Here, “non-transitory” means permanent, semi-permanent, or at least temporarily persistent storage and encompasses both long-term storage in non-volatile memory and storage in working memory, e.g., for program execution.

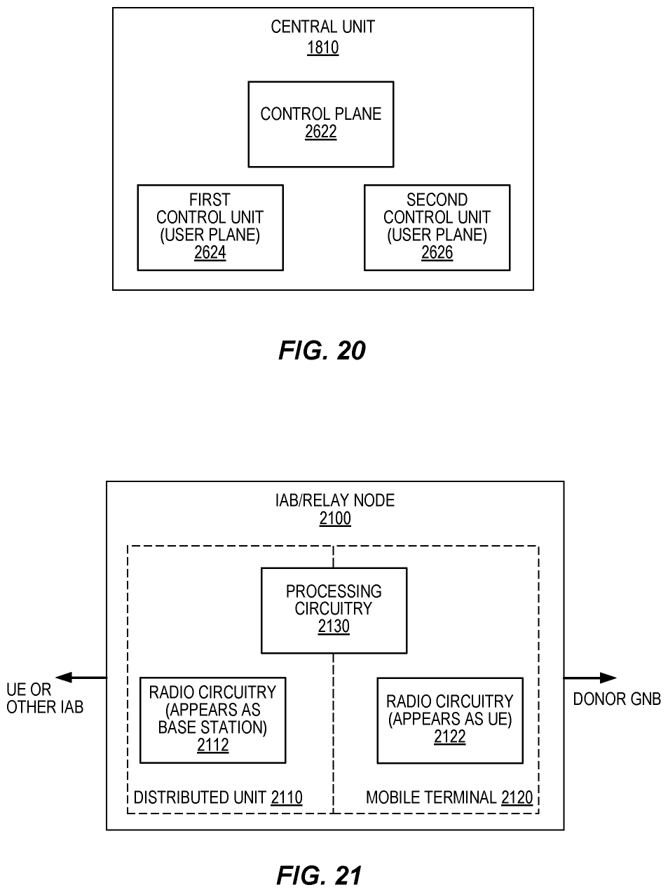

As explained earlier, a gNB-CU may be split into multiple entities. This includes gNB-CU-UPs, which serve the user plane and host the PDCP protocol, and one gNB-CU-CP, which serves the control plane and hosts the PDCP and RRC protocol. These two entities are shown as separate control units in FIG. 20, as control plane 2022 and first and second (user plane) control units 2024 and 2026. Control plane 2022 and control units 2024, 2026 may be comparable to CU-CP and CU-UP in FIG. 2. While FIG. 20 shows both the control plane 2022 and control units 2024, 2026 within central unit 1810, as if located with the same unit of a network node, in other embodiments, the control units 2024, 2026 may be located outside the unit where the control plane 2022 resides, or even in another network node. Without regard to the exact arrangement, the processing circuitry 1912 may be considered to be the processing circuitry in one or more network nodes necessary to carry out the techniques described herein for the central unit 1810, whether the processing circuitry 1912 is together in one unit or whether the processing circuitry 1912 is distributed in some fashion.

FIG. 21 illustrates an exemplary embodiment of an IAB/relay node 2100. The IAB/relay node 2100 may be configured to relay communications between a donor gNB and UEs or other IABs. The IAB/relay node 2100 may include radio circuitry 2112 for facing UEs or other IABS and appearing as a base station to these elements. This radio circuitry 2112 may be considered part of distributed unit 2110. The IAB/relay node 2100 may also include a mobile terminal (MT) part 2120 that includes radio circuitry 2122 for facing a donor gNB. The donor gNB may house the central unit 1810 corresponding to the distributed unit 1830.

The IAB/relay node 2100 may include processing circuitry 2130 that is operatively associated with or controls the radio circuitry 2112, 2122. In an example embodiment, the processing circuitry 2130 comprises one or more digital processors, e.g., one or more microprocessors, microcontrollers, Digital Signal Processors (DSPs), Field Programmable Gate Arrays (FPGAs), Complex Programmable Logic Devices (CPLDs), Application Specific Integrated Circuits (ASICs), or any mix thereof. More generally, the processing circuitry 2130 may comprise fixed circuitry, or programmable circuitry that is specially configured via the execution of program instructions implementing the functionality taught herein.

The processing circuitry 2130 also includes or is associated with storage. The storage, in some embodiments, stores one or more computer programs and, optionally, configuration data. The storage provides non-transitory storage for the computer program and it may comprise one or more types of computer-readable media, such as disk storage, solid-state memory storage, or any mix thereof. By way of non-limiting example, the storage comprises any one or more of SRAM, DRAM, EEPROM, and FLASH memory.

In general, the storage comprises one or more types of computer-readable storage media providing non-transitory storage of the computer program and any configuration data used by the base station. Here, “non-transitory” means permanent, semi-permanent, or at least temporarily persistent storage and encompasses both long-term storage in non-volatile memory and storage in working memory, e.g., for program execution.

According to some embodiments, the processing circuitry 2130 of the IAB/relay node 2100 is configured to map end-user bearers to backhaul bearers for communications with a DU of a donor base station. The processing circuitry 2130 is configured to map first end-user bearers to a first set of backhaul bearers for communications with the DU via a first MT entity in the relay node and map second end-user bearers to a second set of backhaul bearers for communications with the DU via a second MT entity in the relay node. The processing circuitry 2130 is also configured to exchange data with the DU over the first and second sets of backhaul bearers, via the first and second MT entities, respectively. In some embodiments, the first and second MT entities are implemented with separate first and second transceiver circuits, respectively. In other embodiments, the first and second MT entities are implemented with a shared transceiver circuit.

In some embodiments, the processing circuitry 2130 is configured to map the first end-user bearers to the first set of backhaul bearers by mapping end-user bearers for all UEs connected to a first relay node to the first set of backhaul bearers, and map the second end-user bearers to the second set of backhaul bearers by mapping end-user bearers for all UEs connected to a second relay node to the second set of backhaul bearers. The first relay node may be the relay node performing the operation.

In some embodiments, the processing circuitry 2130 is configured to map the first end-user bearers to the first set of backhaul bearers by mapping end-user bearers corresponding to a first set of QCI values to the first set of backhaul bearers, and map the second end-user bearers to the second set of backhaul bearers by mapping end-user bearers corresponding to a second set of QCI values to the second set of backhaul bearers.

The processing circuitry 2130 may be configured to also execute separate RRC protocol instances for the first and second MT entities and execute separate MAC protocol instances for the first and second MT entities.

The processing circuitry 2130 may be configured to signal, to the donor base station, capability information indicating at least a number of MT entities that the relay node can support. The capability information may further indicate whether supported MT entities are logical or physical entities, power limitations for each or all of the supported MT entities, and/or modulation and coding schemes supported for each or all of the supported MT entities.

The processing circuitry 2130 may be configured to, prior to the mapping of the second end-user bearers to the second set of backhaul bearers, instantiate or activate the second MT entity in response to a determination that the second MT entity is needed. In some embodiments, the determination that the second MT entity is needed is in response to determining that a downstream relay node has connected to the relay node or to another downstream relay node.

The term “downstream” refers to a node that is further away from the core network, in terms of hops. In other embodiments, the determination that the second MT entity is needed is in response to determining that previously instantiated or activated MT entities in the relay node are using all available LCIDs.

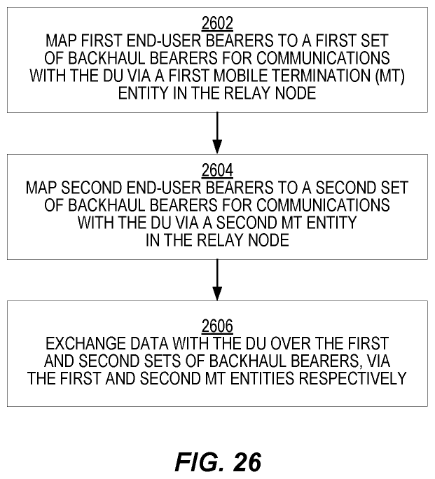

In some embodiments, the processing circuitry 2130 is configured to perform the method shown in FIG. 26.

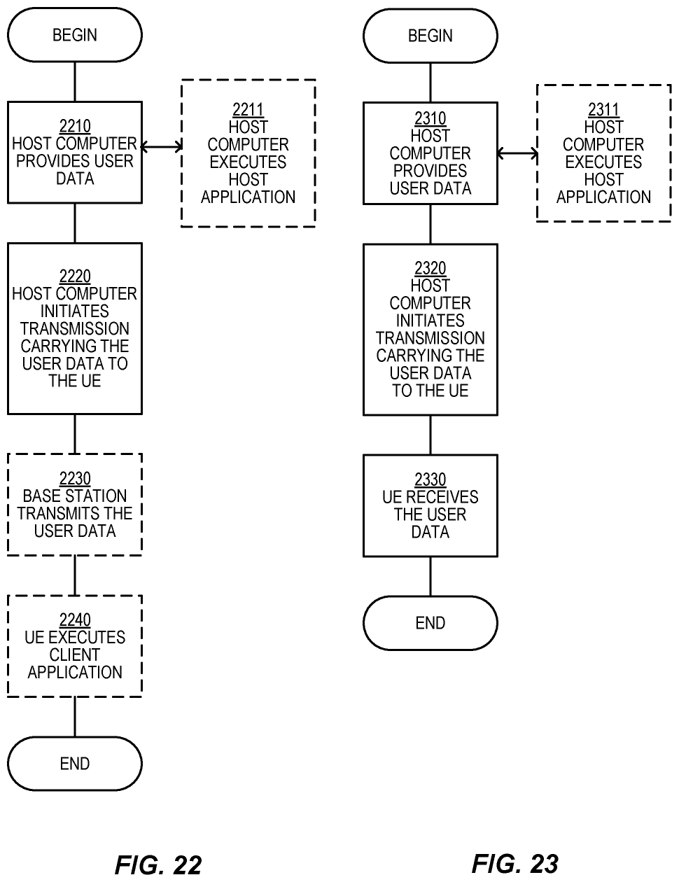

FIG. 22 is a flowchart illustrating an exemplary method and/or procedure implemented in a communication system, in accordance with one embodiment. The communication system includes a host computer, a base station and a UE which, in some exemplary embodiments, can be those described with reference to FIGS. 13 and 14. For simplicity of the present disclosure, only drawing references to FIG. 22 will be included in this section. In step 2210, the host computer provides user data. In substep 2211 (which can be optional) of step 2210, the host computer provides the user data by executing a host application. In step 2220, the host computer initiates a transmission carrying the user data to the UE. In step 2230 (which can be optional), the base station transmits to the UE the user data which was carried in the transmission that the host computer initiated, in accordance with the teachings of the embodiments described throughout this disclosure. In step 2240 (which can also be optional), the UE executes a client application associated with the host application executed by the host computer.

FIG. 23 is a flowchart illustrating an exemplary method and/or procedure implemented in a communication system, in accordance with one embodiment. The communication system includes a host computer, a base station and a UE which can be those described with reference to FIGS. 13 and 14. For simplicity of the present disclosure, only drawing references to FIG. 23 will be included in this section. In step 2310 of the method, the host computer provides user data. In an optional substep 2311, the host computer provides the user data by executing a host application. In step 2320, the host computer initiates a transmission carrying the user data to the UE. The transmission can pass via the base station, in accordance with the teachings of the embodiments described throughout this disclosure. In step 2330 (which can be optional), the UE receives the user data carried in the transmission.

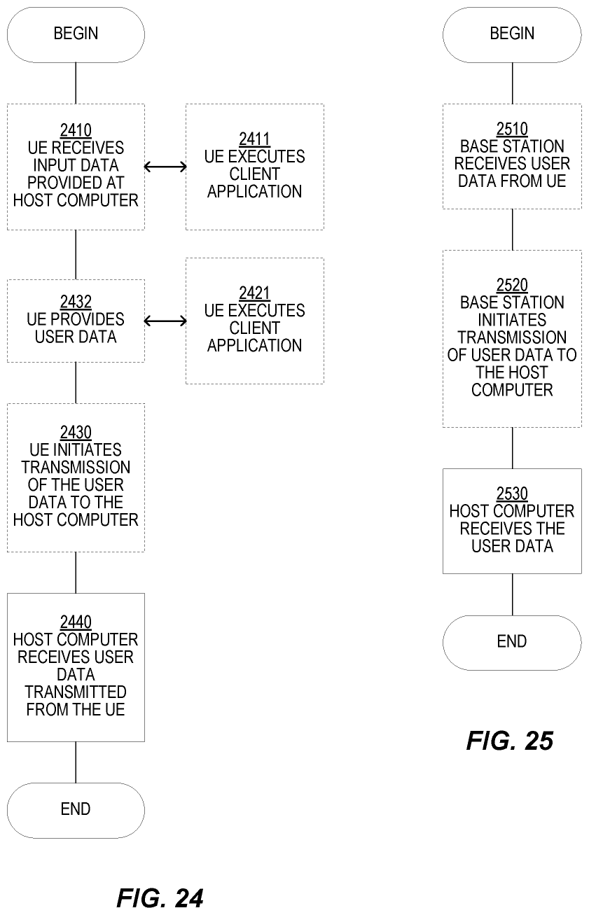

FIG. 24 is a flowchart illustrating an exemplary method and/or procedure implemented in a communication system, in accordance with one embodiment. The communication system includes a host computer, a base station and a UE which can be those described with reference to FIGS. 13 and 14. For simplicity of the present disclosure, only drawing references to FIG. 24 will be included in this section. In step 2410 (which can be optional), the UE receives input data provided by the host computer. Additionally or alternatively, in step 2420, the UE provides user data. In substep 2421 (which can be optional) of step 2420, the UE provides the user data by executing a client application. In substep 2411 (which can be optional) of step 2410, the UE executes a client application which provides the user data in reaction to the received input data provided by the host computer. In providing the user data, the executed client application can further consider user input received from the user. Regardless of the specific manner in which the user data was provided, the UE initiates, in substep 2430 (which can be optional), transmission of the user data to the host computer. In step 2440 of the method, the host computer receives the user data transmitted from the UE, in accordance with the teachings of the embodiments described throughout this disclosure.

FIG. 25 is a flowchart illustrating an exemplary method and/or procedure implemented in a communication system, in accordance with one embodiment. The communication system includes a host computer, a base station and a UE which can be those described with reference to FIGS. 13 and 14. For simplicity of the present disclosure, only drawing references to FIG. 25 will be included in this section. In step 2510 (which can be optional), in accordance with the teachings of the embodiments described throughout this disclosure, the base station receives user data from the UE. In step 2520 (which can be optional), the base station initiates transmission of the received user data to the host computer. In step 2530 (which can be optional), the host computer receives the user data carried in the transmission initiated by the base station.

FIG. 26 illustrates an exemplary method and/or procedure, in a relay node (e.g., IAB relay node), for mapping end-user bearers to backhaul bearers for communications with a DU of a donor base station.

As shown at block 2602, the example method comprises mapping first end-user bearers to a first set of backhaul bearers for communications with the DU via a first MT entity in the relay node. The method also includes mapping second end-user bearers to a second set of backhaul bearers for communications with the DU via a second MT entity in the relay node (block 2604). The method further includes exchanging data with the DU over the first and second sets of backhaul bearers, via the first and second MT entities, respectively (block 2606). In some embodiments, the first and second MT entities are implemented with separate first and second transceiver circuits, respectively. In other embodiments, the first and second MT entities are implemented with a shared transceiver circuit.

In some embodiments, mapping the first end-user bearers to the first set of backhaul bearers includes mapping end-user bearers for all UEs connected to a first relay node to the first set of backhaul bearers, and mapping the second end-user bearers to the second set of backhaul bearers includes mapping end-user bearers for all UEs connected to a second relay node to the second set of backhaul bearers. The first relay node may be the relay node performing the method.

In some embodiments, mapping the first end-user bearers to the first set of backhaul bearers includes mapping end-user bearers corresponding to a first set of quality control indicator (QCI) values to the first set of backhaul bearers, and mapping the second end-user bearers to the second set of backhaul bearers includes mapping end-user bearers corresponding to a second set of QCI values to the second set of backhaul bearers.

The method may further include executing separate RRC protocol instances for the first and second MT entities and executing separate MAC protocol instances for the first and second MT entities.

The method may further include signaling, to the donor base station, capability information indicating at least a number of MT entities that the relay node can support. The capability information may further indicate whether supported MT entities are logical or physical entities, power limitations for each or all of the supported MT entities, and/or modulation and coding schemes supported for each or all of the supported MT entities.

The method may further include, prior to the mapping of the second end-user bearers to the second set of backhaul bearers, instantiating or activating the second MT entity in response to a determination that the second MT entity is needed. In some embodiments, the determination that the second MT entity is needed is in response to determining that a downstream relay node has connected to the relay node or to another downstream relay node. The term “downstream” refers to a node that is further away from the core network, in terms of hops. In other embodiments, the determination that the second MT entity is needed is in response to determining that previously instantiated or activated MT entities in the relay node are using all available LCIDs.

The term unit can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Example embodiments of the techniques and apparatus described herein include, but are not limited to, the following enumerated examples:
(i). A method, in a relay node, for mapping end-user bearers to backhaul bearers for communications with a distributed unit (DU) of a donor base station, the method comprising:
   mapping first end-user bearers to a first set of backhaul bearers for communications with the DU via a first mobile termination (MT) entity in the relay node;
   mapping second end-user bearers to a second set of backhaul bearers for communications with the DU via a second MT entity in the relay node; and
   exchanging data with the DU over the first and second sets of backhaul bearers, via the first and second MT entities, respectively.
(ii). The method of example embodiment (i), wherein the first and second MT entities are implemented with separate first and second transceiver circuits, respectively.
(iii). The method of example embodiment (i), wherein the first and second MT entities are implemented with a shared transceiver circuit.
(iv). The method of any of example embodiments (i)-(iii), wherein mapping the first end-user bearers to the first set of backhaul bearers comprises mapping end-user bearers for all user equipments (UEs) connected to a first relay node to the first set of backhaul bearers, and wherein mapping the second end-user bearers to the second set of backhaul bearers comprises mapping end-user bearers for all UEs connected to a second relay node to the second set of backhaul bearers.
(v). The method of example embodiment (iv), wherein the first relay node is the relay node performing the method.
(vi). The method of any of example embodiments (i)-(iii), wherein mapping the first end-user bearers to the first set of backhaul bearers comprises mapping end-user bearers corresponding to a first set of quality control indicator (QCI) values to the first set of backhaul bearers, and wherein mapping the second end-user bearers to the second set of backhaul bearers comprises mapping end-user bearers corresponding to a second set of QCI values to the second set of backhaul bearers.
(vii). The method of any of example embodiments (i)-(vi), wherein the method further comprises executing separate Radio Resource Control (RRC) protocol instances for the first and second MT entities and executing separate Medium Access Control (MAC) protocol instances for the first and second MT entities.
(viii). The method of any of example embodiments (i)-(vii), wherein the method further comprises signaling, to the donor base station, capability information indicating at least a number of MT entities that the relay node can support.
(ix). The method of example embodiment (viii), wherein the capability information further indicates one or more of any of the following:
   whether supported MT entities are logical or physical entities;
   power limitations for each or all of the supported MT entities;
   modulation and coding schemes supported for each or all of the supported MT entities.
(x). The method of any of example embodiments (i)-(ix), wherein the method further comprises, prior to the mapping of the second end-user bearers to the second set of backhaul bearers, instantiating or activating the second MT entity in response to a determination that the second MT entity is needed.
(xi). The method of example embodiment (x), wherein the determination that the second MT entity is needed is in response to determining that a downstream relay node has connected to the relay node or to another downstream relay node.
(xii). The method of example embodiment (x), wherein the determination that the second MT entity is needed is in response to determining that previously instantiated or activated MT entities in the relay node are using all available logical channel identifiers (LCIDs).
(xiii). A relay node configured to map end-user bearers to backhaul bearers for communications with a distributed unit (DU) of a donor base station, wherein the relay node is configured to perform the method of any of the exemplary embodiments (i)-(xii).
(xiv). A computer program comprising instructions that, when executed on at least one processing circuit, cause the at least one processing circuit to carry out the method according to any one of example embodiments (i) to (xii).
(xv). A carrier containing the computer program of example embodiment (xiv), wherein the carrier is one of an electronic signal, optical signal, radio signal, or computer readable storage medium.
(xvi). A communication system including a host computer comprising:
   processing circuitry configured to provide user data; and
   a communication interface configured to forward the user data to a cellular network for transmission to a user equipment (UE),
   wherein the cellular network comprises a first network node having a radio interface and processing circuitry; and
   the first network node's processing circuitry is configured to perform operations corresponding to any of the methods of embodiments (i)-(xii).
(xvii). The communication system of embodiment (xvi), further including a user equipment configured to communicate with the first network node.
(xviii). The communication system of any of embodiments (xvi)-(xvii), wherein:
   the processing circuitry of the host computer is configured to execute a host application, thereby providing the user data; and
   the UE comprises processing circuitry configured to execute a client application associated with the host application.
(xix). The communication system of any of embodiments (xvi)-(xvii), further comprising a plurality of further network nodes arranged in a multi-hop integrated access backhaul (IAB) configuration, and configured to communicate with the UE via the first network node.
(xx). A method implemented in a communication system including a host computer, first network node, and a user equipment (UE), the method comprising:
   at the host computer, providing user data;
   at the host computer, initiating a transmission carrying the user data to the UE via a cellular network comprising the first network node; and
   operations, performed by a first network node, corresponding to any of the methods of embodiments (i)-(xii).
(xxi). The method of embodiment (xx), further comprising, transmitting the user data by the first network node.
(xxii). The method of any of embodiments (xx)-(xxi), wherein the user data is provided at the host computer by executing a host application, the method further comprising, at the UE, executing a client application associated with the host application.
(xxiii). The method of any of embodiments (xx)-(xxii), further comprising operations, performed by a second network node arranged in a multi-hop integrated access backhaul (IAB) configuration with the first network node, corresponding to any of the methods of embodiments (i)-(xii).
(xxiv). A communication system including a host computer comprising a communication interface configured to receive user data originating from a transmission from a user equipment (UE) to a first network node comprising a radio interface and processing circuitry configured to perform operations corresponding to any of the methods of embodiments (i)-(xii).
(xxv). The communication system of embodiment (xxiv), further including the first network node.
(xxvi). The communication system of embodiments (xxiv)-(xxv), further including a second network node arranged in a multi-hop integrated access backhaul (IAB) configuration with the first network node, and comprising radio interface circuitry and processing circuitry configured to perform operations corresponding to any of the methods of embodiments (i)-(xii).
(xxvii). The communication system of any of embodiments (xxiv)-(xxvi), further including the UE, wherein the UE is configured to communicate with at least one of the first and second network nodes.
(xxviii). The communication system of any of embodiments (xxiv)-(xxvii), wherein:
   the processing circuitry of the host computer is configured to execute a host application;
   the UE is configured to execute a client application associated with the host application, thereby providing the user data to be received by the host computer.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

1-27. (canceled)

28. A method, in a relay node, for mapping end-user bearers to backhaul bearers for communications with a distributed unit (DU) of a donor base station, the method comprising:
mapping first end-user bearers to a first set of backhaul bearers for communications with the DU via a first mobile termination (MT) entity in the relay node;
mapping second end-user bearers to a second set of backhaul bearers for communications with the DU via a second MT entity in the relay node; and
exchanging data with the DU over the first and second sets of backhaul bearers, via the first and second MT entities, respectively.

29. The method of claim 28, wherein mapping the first end-user bearers to the first set of backhaul bearers comprises mapping end-user bearers for all user equipments (UEs) connected to a first relay node to the first set of backhaul bearers, and wherein mapping the second end-user bearers to the second set of backhaul bearers comprises mapping end-user bearers for all UEs connected to a second relay node to the second set of backhaul bearers.

30. The method of claim 28, wherein mapping the first end-user bearers to the first set of backhaul bearers comprises mapping end-user bearers corresponding to a first set of quality control indicator (QCI) values to the first set of backhaul bearers, and wherein mapping the second end-user bearers to the second set of backhaul bearers comprises mapping end-user bearers corresponding to a second set of QCI values to the second set of backhaul bearers.

31. The method of claim 28, wherein the method further comprises executing separate Radio Resource Control (RRC) protocol instances for the first and second MT entities and executing separate Medium Access Control (MAC) protocol instances for the first and second MT entities.

32. The method of claim 28, wherein the method further comprises signaling, to the donor base station, capability information indicating at least a number of MT entities that the relay node can support.

33. The method of claim 32, wherein the capability information further indicates one or more of any of the following:
whether supported MT entities are logical or physical entities;
power limitations for each or all of the supported MT entities;
modulation and coding schemes supported for each or all of the supported MT entities.

34. The method of claim 28, wherein the method further comprises, prior to the mapping of the second end-user bearers to the second set of backhaul bearers, instantiating or activating the second MT entity in response to a determination that the second MT entity is needed.

35. A relay node, comprising:
processing circuitry; and
a memory comprising computer instructions that when executed by the processing circuitry cause the relay node to:
map first end-user bearers to a first set of backhaul bearers for communications with a distributed unit (DU) of a donor base station via a first mobile termination (MT) entity in the relay node;
map second end-user bearers to a second set of backhaul bearers for communications with the DU via a second MT entity in the relay node;. and
exchange data with the DU over the first and second sets of backhaul bearers, via the first and second MT entities, respectively.

36. The relay node of claim 35, wherein the first and second MT entities are implemented with separate first and second transceiver circuits, respectively.

37. The relay node of claim 35, wherein the first and second MT entities are implemented with a shared transceiver circuit.

38. The relay node of claim 35, wherein the computer instructions are configured so that the processing circuitry is configured to map the first end-user bearers to the first set of backhaul bearers by mapping end-user bearers for all user equipments (UEs) connected to a first relay node to the first set of backhaul bearers, and to map the second end-user bearers to the second set of backhaul bearers by mapping end-user bearers for all UEs connected to a second relay node to the second set of backhaul bearers.

39. The relay node of claim 38, wherein the relay node is the first relay node.

40. The relay node of claim 35, wherein the computer instructions are configured so that the processing circuitry is configured to map the first end-user bearers to the first set of backhaul bearers by mapping end-user bearers corresponding to a first set of quality control indicator (QCI) values to the first set of backhaul bearers, and to map the second end-user bearers to the second set of backhaul bearers by mapping end-user bearers corresponding to a second set of QCI values to the second set of backhaul bearers.

41. The relay node of claim 35, wherein the computer instructions are configured so that the processing circuitry is configured to execute separate Radio Resource Control (RRC) protocol instances for the first and second MT entities and to execute separate Medium Access Control (MAC) protocol instances for the first and second MT entities.

42. The relay node of claim 35, wherein the computer instructions are configured so that the processing circuitry is further configured to signal, to the donor base station, capability information indicating at least a number of MT entities that the relay node can support.

43. The relay node of claim 42, wherein the capability information further indicates one or more of any of the following:
whether supported MT entities are logical or physical entities;
power limitations for each or all of the supported MT entities;
modulation and coding schemes supported for each or all of the supported MT entities.

44. The relay node of claim 35, wherein the computer instructions are configured so that the processing circuitry is configured, prior to the mapping of the second end-user bearers to the second set of backhaul bearers, to instantiate or activate the second MT entity in response to a determination that the second MT entity is needed.

45. The relay node of claim 44, wherein the computer instructions are configured so that the processing circuitry is configured to determine that the second MT entity is needed is in response to determining that a downstream relay node has connected to the relay node or to another downstream relay node.

46. The relay node of claim 44, wherein the computer instructions are configured so that the processing circuitry is configured to determine that the second MT entity is needed is in response to determining that previously instantiated or activated MT entities in the relay node are using all available logical channel identifiers, LCIDs.

47. A non-transitory computer-readable medium comprising, stored thereupon, a computer program comprising instructions that, when executed on at least one processing circuit of a relay node, causes the relay node to map end-user bearers to backhaul bearers for communications with a distributed unit (DU) of a donor base station by:
mapping first end-user bearers to a first set of backhaul bearers for communications with the DU via a first mobile termination (MT) entity in the relay node;
mapping second end-user bearers to a second set of backhaul bearers for communications with the DU via a second MT entity in the relay node; and
exchanging data with the DU over the first and second sets of backhaul bearers, via the first and second MT entities, respectively.
